(19) United States
(12) Patent Application Publication
(10) Pub. No.: US 2026/0274501 A1
(43) Pub. Date: Sep. 17, 2026

(54) FOLDABLE STORAGE DEVICE AND CART

(71) Applicant: Taizhou Deyi Plastic Co., Ltd., Taizhou City (CN)

(72) Inventor: Fubin Xiao, Tiane Township (CN)

(21) Appl. No.: 19/079,914

(22) Filed: Mar. 14, 2025

(51) Int. Cl. B65D 6/18; B65D 25/24

(52) U.S. Cl. CPC B65D 11/1826; B65D 25/24

(57) ABSTRACT

A foldable storage device and a cart are provided. The storage device includes a front board unit, a rear board unit, side board units having an inward foldable middle part and bottom board units having upward foldable ends. Two opposite sides of one of the side board units are rotatably installed on one side of the front board unit and one side of the rear board unit, respectively. Two opposite sides of the other of the side board units are rotatably installed on the other side of the front board unit and the other side of the rear board unit, respectively. Two opposite ends of one of the bottom board units are rotatably installed at one end of each of the two side board units at the bottoms of the side board units, respectively. Two opposite ends of the other of the bottom board units are rotatably installed.

### TECHNICAL FIELD

The present disclosure relates to a storage device, in particular to a foldable storage device and a cart.

### BACKGROUND

In the Chinese patent for utility model with the publication patent number of CN214777508U, the inventor discloses a folding storage box. A box body of the folding storage box includes a first fixed box board, a first folding side box board, a second folding side box board, a second fixed box board and a bottom box board. One side of the first folding side box board is hinged to a first side of the first fixed box board, and the other side of the first folding side box board is hinged to a first side of the second fixed box board. One side of the second folding side box board is hinged to a second side of the first fixed box board, and the other side of the second folding side box board is hinged to a second side of the second fixed box board. One side of the bottom box board is hinged to the bottom of the second fixed box board. In the process of folding the box body, first the bottom box board gets close to the second fixed box board to be folded, and then the first folding side box board and the second folding side box board are folded into the box body, respectively. Correspondingly, in the process of unfolding the box body, first the first folding side box board and the second folding side box board are unfolded outside the box body, respectively, and then the bottom box board is unfolded. It can be seen that the folding storage box in the prior art has the defects that the processes of folding and unfolding the side box board and the processes of folding and unfolding the bottom box board need to be carried out respectively, and the operation process is cumbersome. In addition, when the box body of the folding storage box is in a folded state, the first fixed box board and the second fixed box board located on the outer side are not locked. When a user moves the folding storage box in a folded state, the first fixed box board and the second fixed box board are prone to move in opposite directions to cause the folding storage box to be unfolded uncontrollably, or even grip goods or hands of the user.

### SUMMARY

One purpose of the present disclosure is to provide a foldable storage device and a cart, wherein a side board unit and a bottom board unit of the storage device can be linked. A state of the bottom board unit synchronously changes with a change in the state of the side board unit so as to facilitate user operation.

One purpose of the present disclosure is to provide a foldable storage device and a cart, wherein a connected position of a bottom board main board and a bottom board sub-board of the bottom board unit is raised upward. Thus, when the folding unit is folded inward, the state of the bottom board unit smoothly and synchronously changes with the change in the state of the side board unit.

One purpose of the present disclosure is to provide a foldable storage device and a cart, wherein after the storage device is switched to a folded state, a rear board unit and a front board unit of the storage device can be locked, so that the storage device is reliably kept in the folded state to avoid the state of the storage device from changing uncontrollably.

According to the first aspect of the present disclosure, the present disclosure provides a foldable storage device. The foldable storage device includes:

a front board unit;

a rear board unit, wherein the rear board unit and the front board unit are arranged face to face;

two side board units, wherein a middle part of the side board unit is foldable inward, two opposite sides of one of the side board units being rotatably installed on one side of the front board unit and one side of the rear board unit, respectively, and two opposite sides of the other of the side board units being rotatably installed on the other side of the front board unit and the other side of the rear board unit, respectively; and

two bottom board units, wherein two opposite ends of the bottom board unit are foldable upward, two opposite ends of one of the bottom board units being rotatably installed at one end of each of the two side board units at the bottom of the side board unit, respectively, two opposite ends of the other of the bottom board units being rotatably installed at the other ends of the two side board units at the bottom of the side board unit, respectively, and an acute included angle being formed between a folding shaft of the bottom board unit and a rotating shaft of the bottom board unit and the side board unit.

According to one embodiment of the present disclosure, the bottom board unit includes a triangular bottom board main board and two triangular bottom board sub-boards. The bottom board main board is provided with a first main board short side, a second main board short side and a main board long side. The bottom board sub-board is provided with a first sub-board short side, a second sub-board short side and a sub-board long side. The sub-board long side of one of the bottom board sub-boards and the first main board short side of the bottom board main board are connected by a shaft to form one folding shaft of the bottom board unit. The sub-board long side of the other of the bottom board sub-boards and the second main board short side of the bottom board main board are connected by a shaft to form the other folding shaft of the bottom board unit. The first sub-board short sides of the two bottom board sub-boards of one of the bottom board units and one end of each of the two side board units are connected by shafts to form a rotating shaft of the bottom board unit and the side board unit. The first sub-board short sides of the two bottom board sub-boards of the other of the bottom board units and the other ends of the two side board units are connected by shafts to form a rotating shaft of the bottom board unit and the side board unit.

According to one embodiment of the present disclosure, after the bottom board unit is unfolded, a connected position of the bottom board main board and the bottom board sub-board is raised upward.

According to one embodiment of the present disclosure, after the bottom board unit is unfolded, an included angle α is formed between a top surface of the bottom board main board. A top surface of the bottom board sub-board and an included angle β is formed between a bottom surface of the bottom board main board and a bottom surface of the bottom board sub-board. The included angle α is larger than 180°, and the included angle β is smaller than 180°.

According to one embodiment of the present disclosure, the front board unit is provided with at least one locking protrusion. The rear board unit includes a rear board main body, a baffle, an unlocking board, at least one leaf spring, at least one locking hook and at least one locking spring. The baffle is installed on the inner side of the rear board main body. The unlocking board is removably arranged between the rear board main body and the baffle. The leaf spring is configured to have one end keeping still relative to a bottom edge of the rear board main body and the other end abutting against the bottom of the unlocking board. The locking hook is rotatably installed on the baffle and drivably connected to the unlocking board. The locking hook is capable of hooking the locking protrusion of the front board unit. The locking spring is configured to have one end abutting against the baffle and the other end abutting against the locking hook.

According to one embodiment of the present disclosure, the locking hook includes a lock body, a pivotal axis, a hook body and a driven block. The pivotal axis is arranged at the bottom of the lock body. The hook body is arranged in front of the lock body. The driven block is arranged at the back of the lock body. The driven block is provided with a driven inclined plane. A side of the unlocking board is provided with at least one driving block, and the driving block is provided with a driving inclined plane. The baffle is provided with a pair of pivotal holes and a baffle channel adjacent to the pivotal holes, and the baffle channel of the baffle corresponds to the driving block of the unlocking board in a horizontal direction. Two opposite ends of the pivotal axis of the locking hook are rotatably installed in the pair of pivotal holes of the baffle, respectively. The driven block extends to the driving block of the unlocking board through the baffle channel of the baffle. The driven inclined plane of the driven block is laminated to the driving inclined plane of the driving block. An end of the locking spring abuts against the bottom of the hook body.

According to one embodiment of the present disclosure, the rear board unit includes a blocked part. The blocked part is arranged on the top of the unlocking board. The blocked part is capable of being blocked or released by a top edge of the rear board main body. When the blocked part is blocked by the top edge of the rear board main body, the leaf spring is in a compressed state by the unlocking board and the rear board main body. When the blocked part is released by the top edge of the rear board main body, the leaf spring pushes the unlocking board to move upward, so that the driving block and the driven block coordinate with each other for driving the locking hook to rotate.

According to one embodiment of the present disclosure, the rear board main body is provided with an operation channel. A part, adjacent to the blocked part, of the unlocking board corresponds to the operation channel of the rear board main body, or the blocked part corresponds to the operation channel of the rear board main body.

According to one embodiment of the present disclosure, the locking hook includes a lock body, a pivotal axis, a hook body and a driven block. The pivotal axis is arranged at the bottom of the lock body. The hook body is arranged in front of the lock body. The driven block is arranged at the back of the lock body. The driven block is provided with a driven inclined plane. A side of the unlocking board is provided with at least one driving block, and the driving block being provided with a driving inclined plane. The baffle is provided with a first pivotal hole and a baffle channel adjacent to the first pivotal hole. The baffle channel of the baffle corresponds to the driving block of the unlocking board in a horizontal direction. The rear board main body is provided with a second pivotal hole. The second pivotal hole of the rear board main body corresponds to the first pivotal hole of the baffle in a horizontal direction. Two opposite ends of the pivotal axis of the locking hook are rotatably installed in the first pivotal hole of the baffle and the second pivotal hole of the rear board main body, respectively. The driven block extends to the driving block of the unlocking board through the baffle channel of the baffle. The driven inclined plane of the driven block is laminated to the driving inclined plane of the driving block. An end of the locking spring abuts against the bottom of the hook body.

According to one embodiment of the present disclosure, the rear board unit includes a spring seat. The spring seat includes a fixed seat and a movable seat removably installed on the fixed seat up and down. The fixed seat is fixedly installed on the rear board main body. The top of the movable seat is capable of abutting against the bottom of the unlocking board. The bottom of the leaf spring abuts against the bottom edge of the rear board main body. The top of the leaf spring abuts against the movable seat.

According to one embodiment of the present disclosure, the fixed seat includes a seat cylinder and a locking arm extending outward from the seat cylinder. The locking arm is locked on the rear board main body. The seat cylinder is provided with a movable cavity, a bottom opening, a top opening and at least one limit slot. The bottom opening and the top opening are formed in the bottom and the top of the movable cavity, respectively. The limit slot communicates with the movable cavity and extends in a direction from the bottom opening to the top opening. The movable seat includes a seat body and at least one limit arm extending from the bottom of the seat body to a side of the seat body. The seat body is provided with a first spring slot. The movable seat is installed in the movable cavity of the seat cylinder through the bottom opening of the seat cylinder. The top of the seat body is capable of extending to the outside of the seat cylinder through the top opening of the seat cylinder. The limit arm of the movable seat is slidably arranged in the limit slot of the seat cylinder. The top of the leaf spring is accommodated in the first spring slot of the seat body.

According to one embodiment of the present disclosure, the storage device includes a locking unit. The locking unit is operatively arranged on the rear board main body, and the locking unit is configured to lock or release the unlocking board.

According to one embodiment of the present disclosure, the unlocking board is provided with a locking slot. The rear board main body is provided with an operation channel. The locking unit includes an operation part and a reset part. The operation part is operably installed on the rear board main body and corresponds to the operation channel. The reset part is arranged between the operation part and the rear board main body for resetting the operation part after being operated. The operation part is provided with a locking piece. The locking piece of the operation part is configured to be capable of stretching into or exiting the locking slot of the unlocking board. When the locking piece stretches into the locking slot of the unlocking board, the locking unit locks the unlocking board. When the locking piece exits the locking slot of the unlocking board, the locking unit releases the unlocking board.

According to one embodiment of the present disclosure, the operation part is rotatably installed at the bottom of the rear board main body.

According to another aspect of the present disclosure, the present disclosure further provides a foldable storage device. The foldable storage device includes a front board unit rear board unit, two side board units and two bottom board units and has an unfolded state and a folded state.

Each of the side board units includes a first side board and a second side board, respectively. One side of the first side board and one side of the second side board are connected by a shaft. The other side of the first side board and one side of the front board unit are connected by a shaft. The other side of the second side board and one side of the rear board unit are connected by a shaft.

Each of the bottom board units includes a triangular bottom board main board and two triangular bottom board sub-boards, respectively. The bottom board main board is provided with a first main board short side, a second main board short side and a main board long side. The bottom board sub-board is provided with a first sub-board short side, a second sub-board short side and a sub-board long side. The sub-board long sides of the two bottom board sub-boards are connected to the first main board short side and the second main board short side of the bottom board main board by shafts, respectively. The first sub-board short sides of the two bottom board sub-boards of one of the bottom board units is connected to the bottoms of the first side boards of the two side board units by shafts, respectively. The first sub-board short sides of the two bottom board sub-boards of the other of the bottom board units are connected to the bottoms of the second side boards of the two side board units by shafts, respectively. When the first side board and the second side board rotate relatively, the bottom board sub-board rotates synchronously with the first side board or the second side board relative to the bottom board main board, so that the storage device is capable of being switched in the state and the folded state.

According to one embodiment of the present disclosure, when the storage device is in the unfolded state, a connected position of the bottom board main board and the bottom board sub-board is raised upward.

According to one embodiment of the present disclosure, when the storage device is in the unfolded state, an included angle α is formed between a top surface of the bottom board main board. A top surface of the bottom board sub-board and an included angle β is formed between a bottom surface of the bottom board main board and a bottom surface of the bottom board sub-board. The included angle α is larger than 180°, and the included angle β is smaller than 180°.

According to one embodiment of the present disclosure, when the storage device is in the unfolded state, the main board long side of the bottom board main board of one of the bottom board units leans against the bottom of the front board unit. The main board long side of the bottom board main board of the other of the bottom board units leans against the bottom of the rear board unit. The second sub-board short side of each bottom board sub-board of one of the bottom board units and the second sub-board short side of each bottom board sub-board of the other of the bottom board units lean against each other.

According to one embodiment of the present disclosure, the bottom board main board is provided with at least one first main board leaning buckle and at least one first main board leaning slot on the first main board short side and the second main board short side, respectively. The first main board leaning buckle and the first main board leaning slot are staggered mutually. The bottom board sub-board is provided with at least one first sub-board leaning buckle and at least one first sub-board leaning slot on the sub-board long side, respectively. The first sub-board leaning buckle and the first sub-board leaning slot are staggered mutually. When the storage device is in the unfolded state, the first main board leaning buckle of the bottom board main board leans against the bottom board sub-board and is accommodated in the first sub-board leaning slot of the bottom board sub-board, and the first sub-board leaning buckle of the bottom board sub-board leans against the bottom board main board and is accommodated in the first main board leaning slot of the bottom board main board.

According to one embodiment of the present disclosure, the first main board leaning buckle of the bottom board main board is provided with a first main board buckle body. The first main board leaning slot of the bottom board main board is provided with a first main board buckle slot. The first sub-board leaning buckle of the bottom board sub-board is provided with a first sub-board buckle body. The first sub-board leaning slot of the bottom board sub-board is provided with a first sub-board buckle slot. The first main board buckle body of the first main board leaning buckle is capable of being buckled in the first sub-board buckle slot of the bottom board sub-board. The first sub-board buckle body of the first sub-board leaning buckle is capable of being buckled in the first main board buckle slot of the bottom board main board.

According to one embodiment of the present disclosure, the bottom board sub-board is provided with at least one second sub-board leaning buckle and at least one second sub-board leaning slot on the second sub-board short side. The second sub-board leaning buckle and the second sub-board leaning slot are staggered mutually. When the storage device is in the unfolded state, the second sub-board leaning buckle of one of the bottom board sub-boards leans against the other of the bottom board sub-boards and is accommodated in the second sub-board leaning slot of this bottom board sub-board.

According to one embodiment of the present disclosure, a portion, located between the second sub-board short sides of the two bottom board sub-boards, of the bottom board main board is provided with at least one second main board leaning buckle and at least one second main board leaning slot. When the storage device is in the unfolded state, the second main board leaning buckle of the bottom board main board of one of the bottom board units leans against the other of the bottom board main boards and is accommodated in the second main board leaning slot of this bottom board main board.

According to one embodiment of the present disclosure, the second main board leaning buckle of the bottom board main board is provided with a second main board buckle body. The second main board leaning slot of the bottom board main board is provided with a second main board buckle slot. The second main board buckle body of the second main board leaning buckle of one of the bottom board main boards is capable of being buckled in the second main board buckle slot of the second main board leaning slot of the other of the bottom board main boards.

According to one embodiment of the present disclosure, the front board unit is provided with at least one locking protrusion. The rear board unit includes a rear board main body, a baffle, an unlocking board, at least one leaf spring, at least one locking hook and at least one locking spring. The baffle is installed on the inner side of the rear board main body. The unlocking board is removably arranged between the rear board main body and the baffle. The leaf spring is configured to have one end keeping still relative to a bottom edge of the rear board main body and the other end abutting against the bottom of the unlocking board. The locking hook is rotatably installed on the baffle and drivably connected to the unlocking board. The locking hook is capable of hooking the locking protrusion of the front board unit. The locking spring is configured to have one end abutting against the baffle and the other end abutting against the locking hook.

According to another aspect of the present disclosure, the present disclosure further provides a cart. The cart includes a pull rod, a set of wheels and a foldable storage device. The storage device includes:

a front board unit;

a rear board unit, wherein the rear board unit and the front board unit are arranged face to face;

two side board units, wherein a middle part of the side board unit is foldable inward, two opposite sides of one of the side board units being rotatably installed on one side of the front board unit and one side of the rear board unit, respectively, and two opposite sides of the other of the side board units being rotatably installed on the other side of the front board unit and the other side of the rear board unit, respectively; and

two bottom board units, wherein two opposite ends of the bottom board unit are foldable upward, two opposite ends of one of the bottom board units being rotatably installed at one end of each of the two side board units at the bottom of the side board unit, respectively, two opposite ends of the other of the bottom board units being rotatably installed at the other ends of the two side board units at the bottom of the side board unit, respectively, and an acute included angle being formed between a folding shaft of the bottom board unit and a rotating shaft of the bottom board unit and the side board unit; wherein the pull rod being installed on the rear board unit; wherein the wheels being installed at the bottom of the front board unit and the bottom of the rear board unit, respectively, or the wheels being installed at the bottom of the rear board unit.

According to another aspect of the present disclosure, the present disclosure further provides a cart. The cart includes a pull rod, a set of wheels and a foldable storage device. The storage device includes a front board unit, a rear board unit, two side board units and two bottom board units and has an unfolded state and a folded state.

Each of the side board units includes a first side board and a second side board, respectively. One side of the first side board and one side of the second side board are connected by a shaft. The other side of the first side board and one side of the front board unit are connected by a shaft. The other side of the second side board and one side of the rear board unit are connected by a shaft.

Each of the bottom board units includes a triangular bottom board main board and two triangular bottom board sub-boards, respectively. The bottom board main board is provided with a first main board short side, a second main board short side and a main board long side. The bottom board sub-board is provided with a first sub-board short side, a second sub-board short side and a sub-board long side. The sub-board long sides of the two bottom board sub-boards are connected to the first main board short side and the second main board short side of the bottom board main board by shafts, respectively. The first sub-board short sides of the two bottom board sub-boards of one of the bottom board units is connected to the bottoms of the first side boards of the two side board units by shafts, respectively. The first sub-board short sides of the two bottom board sub-boards of the other of the bottom board units are connected to the bottoms of the second side boards of the two side board units by shafts, respectively. When the first side board and the second side board rotate relatively, the bottom board sub-board rotates synchronously with the first side board or the second side board relative to the bottom board main board, so that the storage device is capable of being switched in the state and the folded state. The pull rod is installed on the rear board unit. The wheels are installed at the bottom of the front board unit and the bottom of the rear board unit, respectively, or the wheels are installed at the bottom of the rear board unit.

### BRIEF DESCRIPTION OF THE DRAWINGS

FIG. 1A and FIG. 1B are solid diagrams of a foldable storage device in an unfolded state at one visual angle according to a preferred embodiment of the present disclosure.

FIG. 2 is an enlarged view of FIG. 1B at one local position.

FIG. 3 is a solid diagram of the storage device in a folded state at one visual angle according to the preferred embodiment of the present disclosure.

FIG. 4 is a solid diagram of the storage device in a folded state at another visual angle according to the preferred embodiment of the present disclosure.

FIG. 5 is an exploded view of the storage device in an unfolded state at one visual angle according to the preferred embodiment of the present disclosure.

FIG. 6 is an exploded view of the storage device in an unfolded state at another visual angle according to the preferred embodiment of the present disclosure.

FIG. 7 is a section view of the storage device in a folded state at one position according to the preferred embodiment of the present disclosure.

FIG. 8 is an enlarged view of FIG. 7 at one local position.

FIG. 9 is a section view of the storage device in a folded state at another position according to the preferred embodiment of the present disclosure.

FIG. 10 is an enlarged view of FIG. 9 at one local position.

FIG. 11 is a section view of the storage device in a folded state at another position according to the preferred embodiment of the present disclosure.

FIG. 12 is an enlarged view of FIG. 11 at one local position.

FIG. 13 is a solid diagram of a rear board unit of the storage device at one visual angle according to the preferred embodiment of the present disclosure.

FIG. 14 is an enlarged view of FIG. 13 at one local position.

FIG. 15 is a solid diagram of the rear board unit of the storage device at another visual angle according to the preferred embodiment of the present disclosure.

FIG. 16 is an enlarged view of FIG. 15 at one local position.

FIG. 17 is an exploded view of the rear board unit of the storage device at one visual angle according to the preferred embodiment of the present disclosure.

FIG. 18 is an enlarged view of FIG. 17 at one local position.

FIG. 19 is an enlarged view of FIG. 17 at another local position.

FIG. 20 is an exploded view of the rear board unit of the storage device at another visual angle according to the preferred embodiment of the present disclosure.

FIG. 21 is an enlarged view of FIG. 20 at one local position.

FIG. 22 is an enlarged view of FIG. 20 at another local position.

FIG. 23 is a solid diagram of one local structure of the rear board unit of the storage device according to the preferred embodiment of the present disclosure.

FIG. 24 is an enlarged view of FIG. 23 at one local position.

FIG. 25 is an enlarged view of FIG. 23 at another local position.

FIG. 26 is a solid diagram of two bottom board units of the storage device at one visual angle according to the preferred embodiment of the present disclosure.

FIG. 27 is a solid diagram of the two bottom board units of the storage device at another visual angle according to the preferred embodiment of the present disclosure.

FIG. 28 is an exploded view of the two bottom board units of the storage device at one visual angle according to the preferred embodiment of the present disclosure.

FIG. 29 is an exploded view of the two bottom board units of the storage device at another visual angle according to the preferred embodiment of the present disclosure.

FIG. 30 is a section view of the two bottom board units of the storage device at the one local position according to the preferred embodiment of the present disclosure.

FIG. 31 is a section view of the two bottom board units of the storage device at the other local position according to the preferred embodiment of the present disclosure.

FIG. 32 is a solid diagram of the one bottom board unit of the storage device at one visual angle according to the preferred embodiment of the present disclosure.

FIG. 33 is a solid diagram of the one bottom board unit of the storage device at another visual angle according to the preferred embodiment of the present disclosure.

FIG. 34 is an exploded view of one side board unit of the storage device at one visual angle according to the preferred embodiment of the present disclosure.

FIG. 35 is an exploded view of the side board unit of the storage device at another visual angle according to the preferred embodiment of the present disclosure.

FIG. 36 is a solid diagram of the rear board unit of the storage device in one deformed example according to the preferred embodiment of the present disclosure.

FIG. 37 is an exploded view of the rear board unit of the storage device at one visual angle according to the preferred embodiment of the present disclosure.

FIG. 38 is an exploded view of the rear board unit of the storage device at another visual angle according to the preferred embodiment of the present disclosure.

FIG. 39 is a solid diagram of the rear board unit of the storage device at one local position according to the preferred embodiment of the present disclosure.

FIG. 40 is a section view of the rear board unit of the storage device at the local position according to the preferred embodiment of the present disclosure.

FIG. 41 is a section view of the rear board unit of the storage device at a three-dimensional visual angle at one position according to the preferred embodiment of the present disclosure.

FIG. 42 is an enlarged view of FIG. 41 at one local position.

FIG. 43 is a section view of the rear board unit of the storage device at a three-dimensional visual angle at another position according to the preferred embodiment of the present disclosure.

FIG. 44 is an enlarged view of FIG. 43 at one local position.

FIG. 45 is a section view of the rear board unit of the storage device at a planar visual angle at another position according to the preferred embodiment of the present disclosure.

FIG. 46 to FIG. 49 are enlarged views of FIG. 45 in different states at one local position, respectively.

### DETAILED DESCRIPTION OF THE EMBODIMENTS

Before any embodiment of the present disclosure is described in detail, it should be understood that the present disclosure is not limited in the application to the details of the construction and arrangement of the components set forth in the following description or illustrated in the following attached figures. The present disclosure may have other embodiments and may be practiced or carried out in various ways. In addition, it should be understood that the phraseology and terminology used herein are for the purpose of description and should not be considered to be restrictive. The use herein of “including” or “having” and variations thereof is intended to encompass the items set forth below and equivalents thereof, as well as additional items. Unless otherwise specified or limited, the terms “installation”, “connection”, “supporting”, and “coupling” and variations thereof are used broadly and encompass both direct installation and indirect installation, connection, supporting and coupling. Further, “connection” and “coupling” are not limited to a physical or mechanical connection or coupling.

Moreover, in the first aspect, in the description of the present disclosure, the indicative direction or position relations of the terms such as “center”, “longitudinal”, “transverse”, “upper”, “lower”, “front”, “rear”, “left”, “right”, “vertical”, “horizontal”, “top”, “bottom”, “inside” and “outside” are direction or position relations illustrated based on the attached figures, just for facilitating the description of the embodiment of the present disclosure and simplifying the description, but not for indicating or hinting that the indicated device or element must be in a specific direction and is constructed and operated in the specific direction, the terms cannot be understood as the restriction of the present disclosure. In the second aspect, the term “one” should be understood as “at least one” or “one or more”, that is, in one embodiment, the number of one element may be one. While in other embodiments, the number of the elements may be multiple, and the term “one” may not be understood as a limitation on the number.

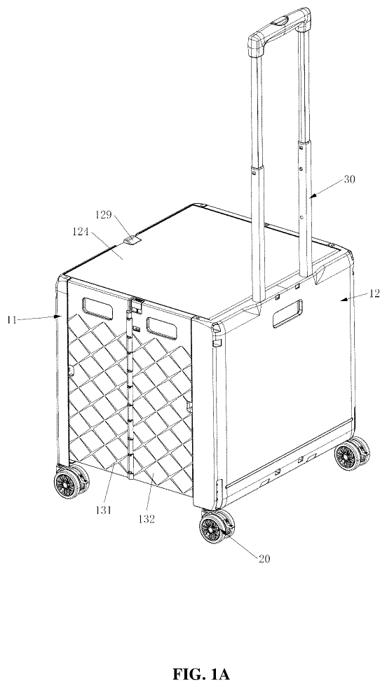

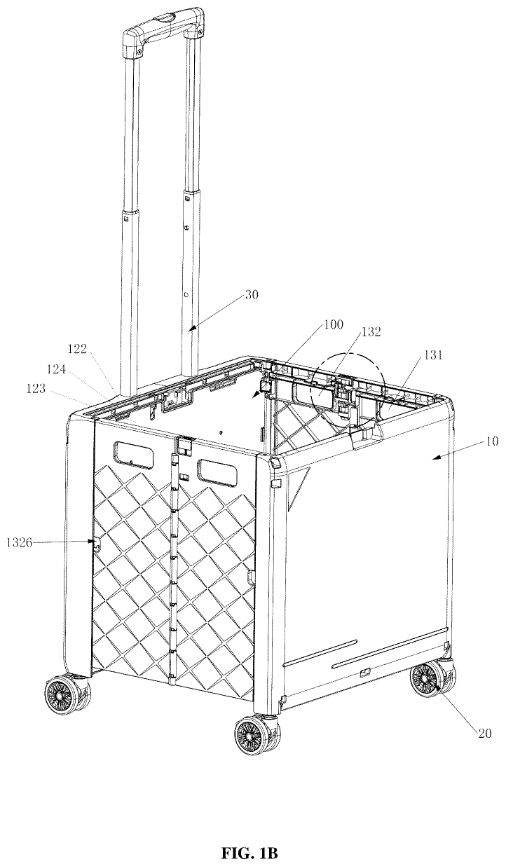

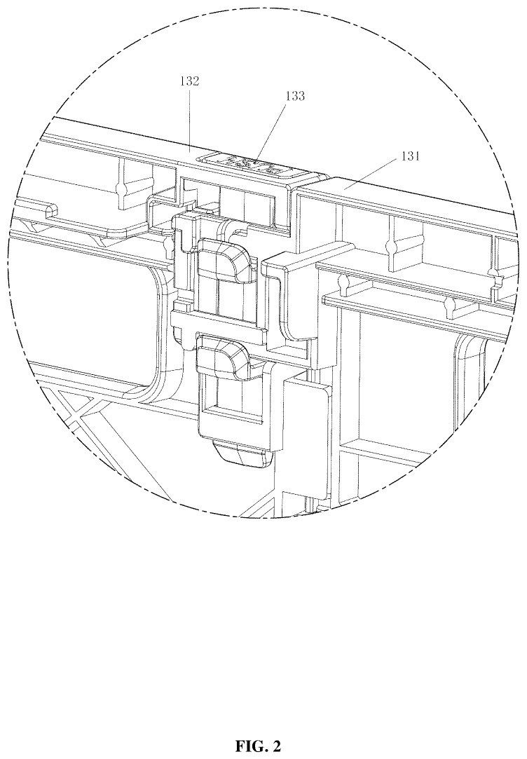

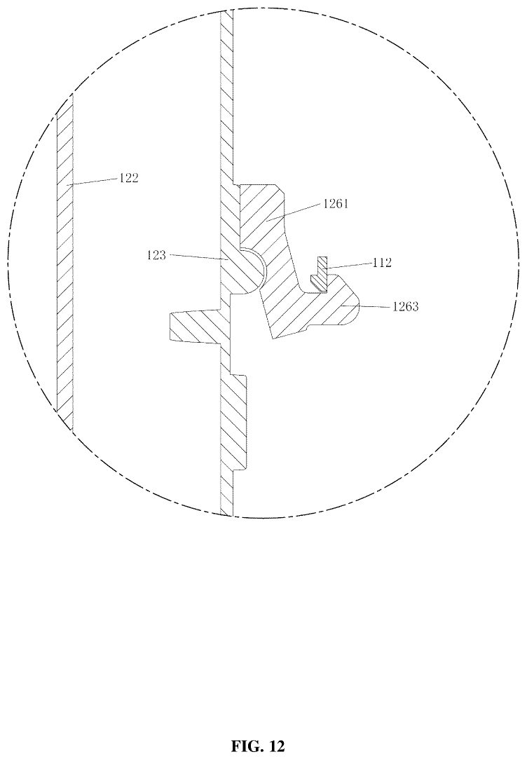

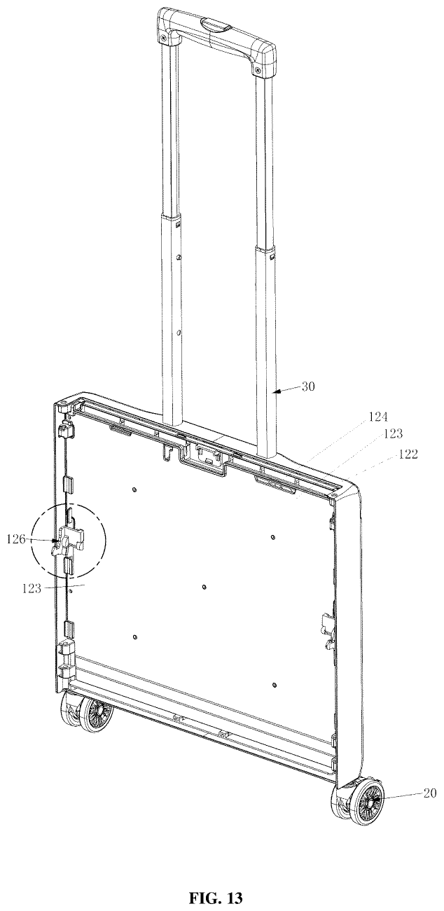

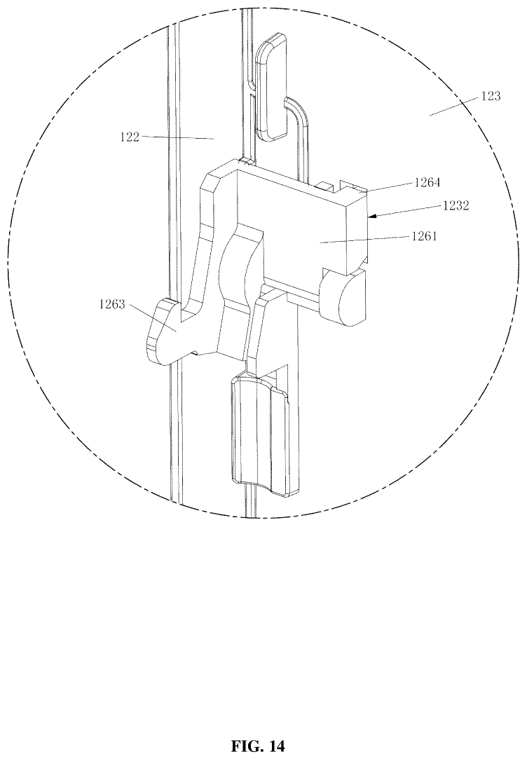

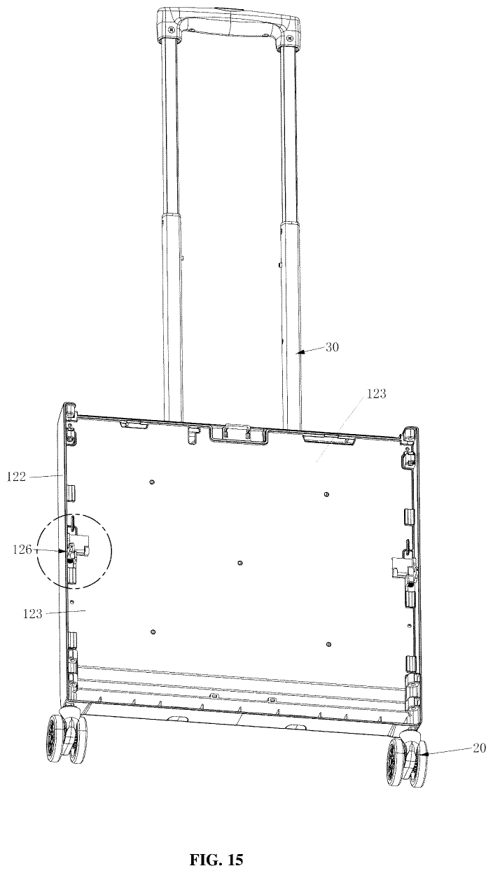

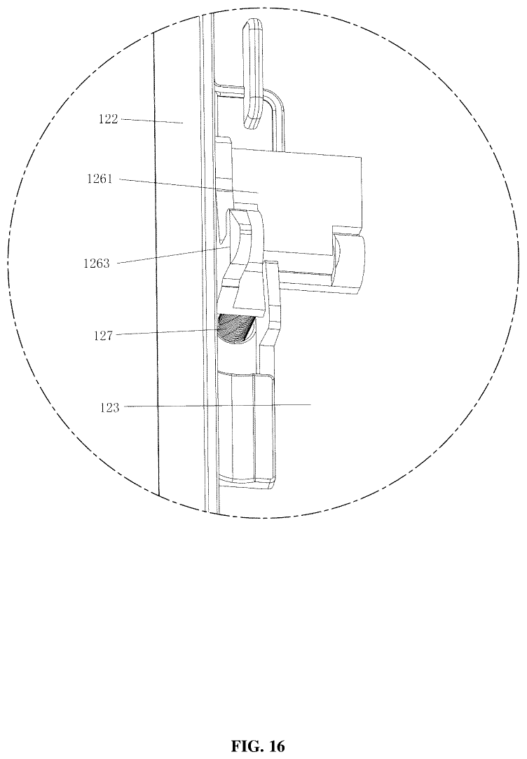

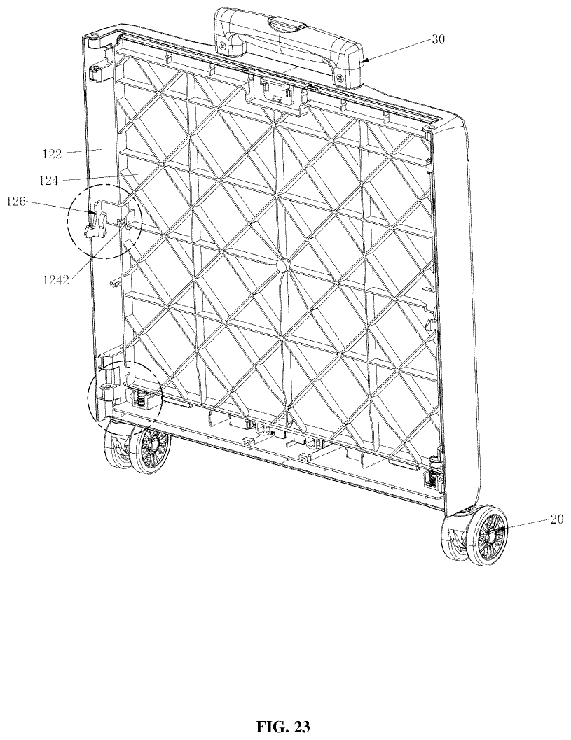

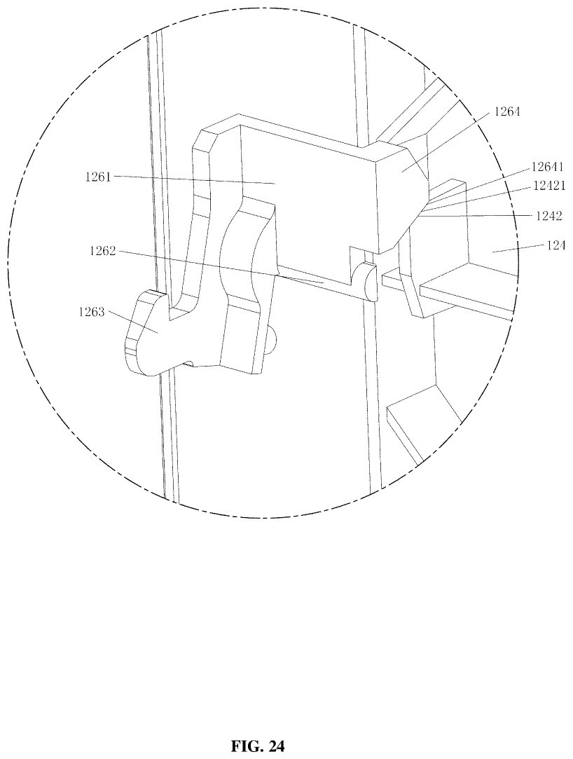

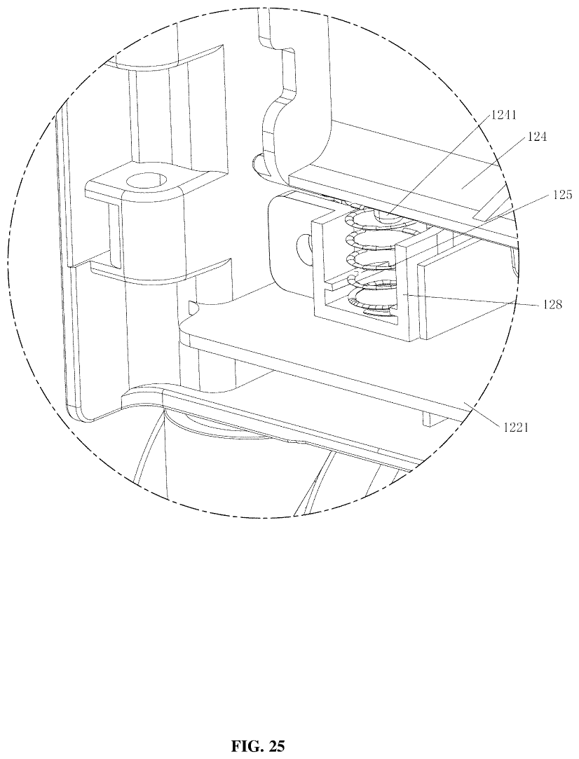

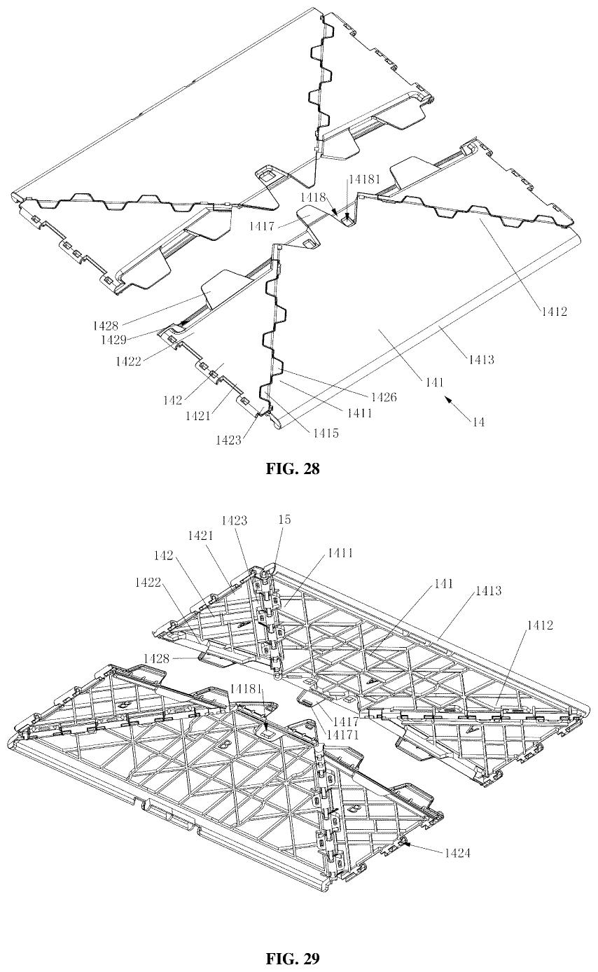

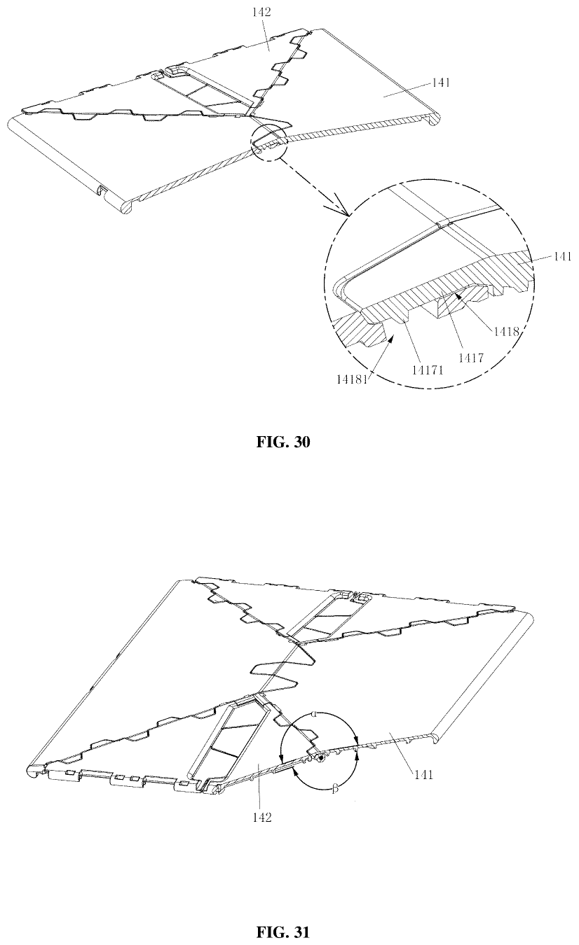

Referring to FIG. 1A to FIG. 35 of attached figures of the specification of the present disclosure, a cart according to a preferred embodiment of the present disclosure is disclosed and elaborated in the following description, wherein the cart includes a foldable storage device 10, a set of wheels 20 and a pull rod 30. The set of wheels 20 are arranged at the bottom of the storage device 10. The pull rod 30 is arranged on the side of the storage device 10.

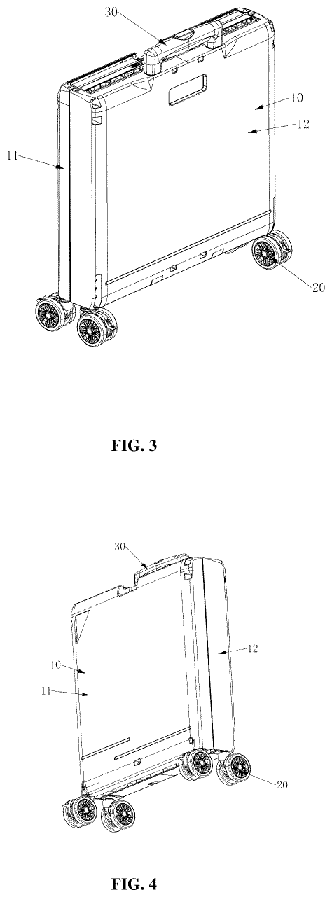

The storage device 10 has an unfolded state and a folded state, and the storage device 10 may be switched between the unfolded state and the folded state. When the storage device 10 is in the unfolded state. As shown in FIG. 1B, the storage device 10 forms a storage cavity 100 for storing articles. When the storage device 10 is in the folded state, as shown in FIG. 3 and FIG. 4, the storage device 10 has a small size.

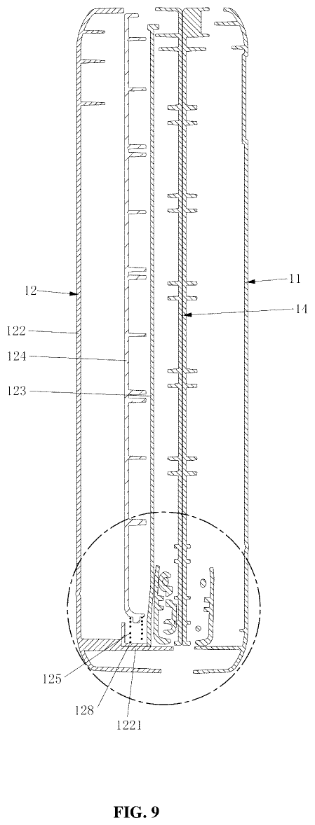

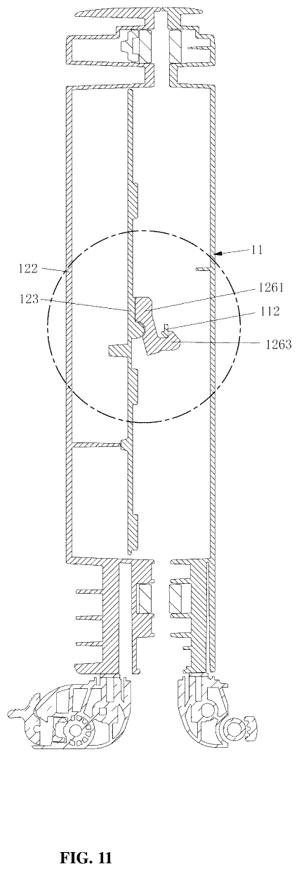

In one example of the cart in the present disclosure, as shown in FIG. 1A, FIG. 1B, FIG. 3 to FIG. 7, FIG. 9 and FIG. 11, the storage device 10 includes a front board unit 11, a rear board unit 12, two side board units 13 and two bottom board units 14.

The front board unit 11 and the rear board unit 12 are arranged face to face. In this specific example of the cart in the present disclosure as shown in FIG. 1A to FIG. 35, one of the wheels 20 is respectively installed on two opposite sides of the bottom of the front board unit 11, and one of the wheels 20 is respectively installed on two opposite sides of the bottom of the rear board unit 12. Optionally, in other examples of the cart in the present disclosure, one of the wheels 20 may be only respectively installed on two opposite sides of the bottom of the rear board unit 12 of the cart. The pull rod 30 is installed on the rear board unit 12. Preferably, the pull rod 30 is a telescopic rod with an adjustable height.

The middle part of each of the side board units 13 is foldable. Specifically, each of the side board units 13 respectively includes a first side board 131 and a second side board 132. One side of the first side board 131 and one side of the second side board 132 are connected by a shaft, so that the middle part of the side board unit 13 is foldable. one side, away from the second side board 132, of the first side board 131 of one of the side board units 13 is connected to one side of the front board unit 11 by a shaft. One side, away from the first side board 131, of the second side board 132 of this side board unit 13 is connected to one side of the rear board unit 12 by a shaft. That is, two opposite sides of this side board unit 13 are rotatably installed on one side of the front board unit 11 and one side of the rear board unit 12, respectively. One side, away from the second side board 132, of the first side board 131 of the other side board unit 13 is connected to the other side of the front board unit 11 by a shaft. One side, away from the first side board 131, of the second side board 132 of this side board unit 13 is connected to the other side of the rear board unit 12 by a shaft. That is, two opposite sides of this side board unit 13 are rotatably installed on the other side of the front board unit 11 and the other side of the rear board unit 12, respectively.

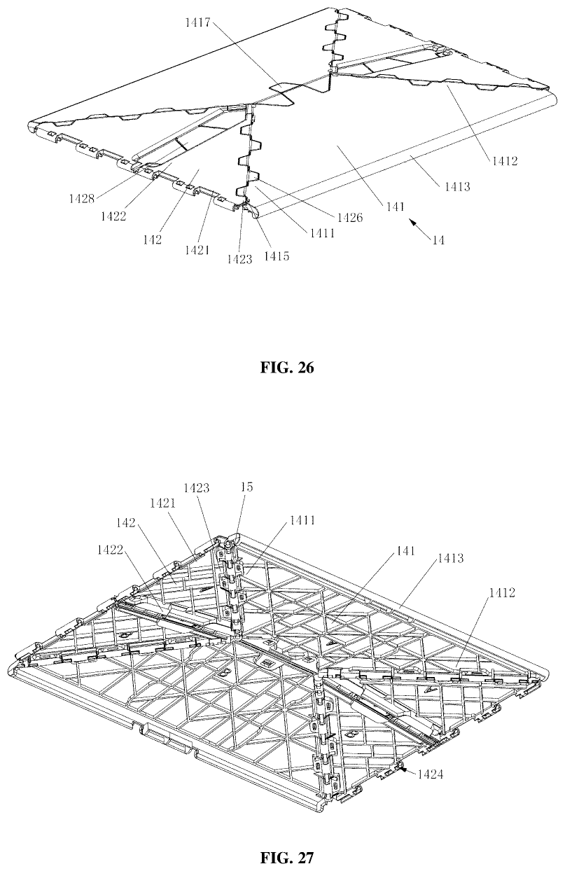

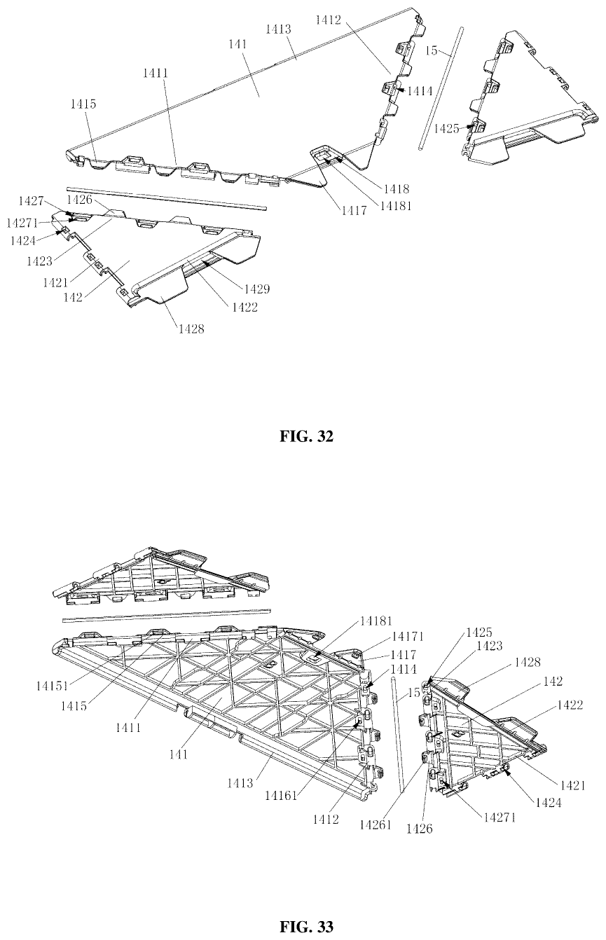

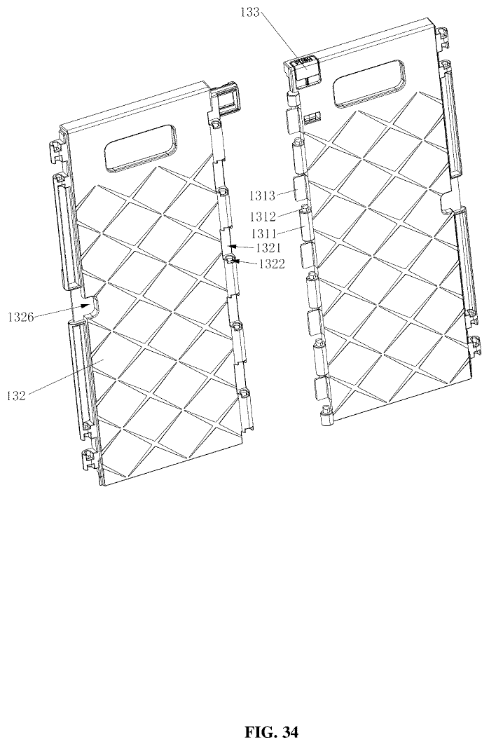

Two ends of each of the bottom board units 14 are foldable. Specifically, referring to FIG. 26 and FIG. 32, each of the bottom board units 14 includes a bottom board main board 141 and two bottom board sub-boards 142, respectively. Each of the bottom board sub-boards 142 is rotatably installed at one end of the bottom board main board 141. A folding shaft is formed at a connected position of this bottom board sub-board 142 and the bottom board main board 141. The other of the bottom board sub-boards 142 is rotatably installed at the other end of the bottom board main board 141. Another folding shaft is formed at a connected position of this bottom board sub-board 142 and the bottom board main board 141. Thus, two ends of the bottom board unit 14 are foldable.

More specifically, referring to FIG. 26 to FIG. 33, the bottom board main board 141 is triangular. The bottom board main board 141 is provided with a first main board short side 1411, a second main board short side 1412 and a main board long side 1413. The bottom board sub-board 142 is triangular. The bottom board sub-board 142 is provided with a first sub-board short side 1421, a second sub-board short side 1422 and a sub-board long side 1423. The first main board short side 1411 of the bottom board main board 141 and the sub-board long side 1423 of one of the bottom board sub-boards 142 are connected by a shaft. Thus, this bottom board sub-board 142 is rotatably installed at one end of the bottom board main board 141, so that this end of the bottom board unit 14 is foldable. The second main board short side 1412 of the bottom board main board 141 and the sub-board long side 1423 of the other of the bottom board sub-boards 142 are connected by a shaft. Thus, this bottom board sub-board 142 is rotatably installed at one end of the bottom board main board 141, so that this end of the bottom board unit 14 is foldable.

In this specific example of the cart in the present disclosure as shown in FIG. 1A to FIG. 35, from an overlooking visual angle, the bottom board main board 141 and the bottom board sub-board 142 are both right angled isosceles triangles. Thus, after the bottom board unit 14 is folded, the bottom board unit 14 is rectangular.

The main board long side 1413 of the bottom board main board 141 of one of the bottom board units 14 is adjacent to the bottom of the front board unit 11. The first sub-board short side 1421 of one of the bottom board sub-boards 142 of this bottom board unit 14 and the bottom of the first side board 131 of one of the side board units 13 are connected by a shaft. The first sub-board short side 1421 of the other of the bottom board sub-boards 142 and the bottom of the first side board 131 of the other of the side board units 13 are connected by a shaft. The main board long side 1413 of the bottom board main board 141 of the other of the bottom board units 14 is adjacent to the bottom of the rear board unit 12. The first sub-board short side 1421 of one of the bottom board sub-boards 142 of this bottom board unit 14 and the bottom of the second side board 132 of one of the side board units 13 are connected by a shaft. The first sub-board short side 1421 of the other of the bottom board sub-boards 142 and the bottom of the second side board 132 of the other of the side board units 13 are connected by a shaft.

In other words, two opposite ends of one of the bottom board units 14 are rotatably installed at one end of each of the two side board units at the bottom of the side board unit 13, respectively. Two opposite ends of the other of the bottom board units 14 are rotatably installed at the other ends of the two side board units 13 at the bottom of the side board unit 13, respectively. An acute included angle is formed between a folding shaft of the bottom board unit 14 and a rotating shaft of the bottom board unit 14 and the side board unit 13. In this manner, the side board unit 13 and the bottom board unit 14 may be linked. The state of the bottom board unit 14 changes synchronously with a change in the state of the side board unit 13. That is, when the side board unit 13 is unfolded, the bottom board unit 14 is driven by the side board unit 13 to be unfolded synchronously. When the side board unit 13 is folded, the bottom board unit 14 is driven by the side board unit 13 to be folded synchronously so as to facilitate user operation.

Specifically, the middle part of the side board unit 13 is pushed in a direction towards the storage cavity 100 of the storage device 10, so that when the first side board 131 and the second side board 132 rotate around a rotating shaft of the first side board 131 and the second side board 132 to fold the side board unit 13 inward, firstly, the first side board 131 and the front board unit 11 rotate around a rotating shaft of the first side board 131 and the front board unit 11, secondly, the second side board 132 and the rear board unit 12 rotate around a rotating shaft of the second side board 132 and the rear board unit 12, thirdly, the bottom board sub-board 142 and the bottom board main board 141 of the bottom board unit 14 rotate around a rotating shaft (a folding shaft) of the bottom board sub-board 142 and the bottom board main board 141 so that the bottom board unit 14 is folded upward, fourthly, the bottom board sub-board 142 of one of the bottom board units 14 and the first side board 131 rotate around a rotating shaft of the bottom board sub-board 142 and the first side board 131, and fifthly, the bottom board sub-board 142 of the other of the bottom board units 14 and the second side board 132 rotate around a rotating shaft of this bottom board sub-board 142 and the second side board 132, so that the storage device 10 may be switched from the unfolded state to the folded state. That is to say, with such one action that the middle part of the side board unit 13 is pushed in a direction towards the storage cavity 100 of the storage device 10 so that the first side board 131 and the second side board 132 rotate around a rotating shaft of the first side board 131 and the second side board 132, the storage device 10 may be switched from the unfolded state to the folded state so as to facilitate user operation. It can be understood that all the above rotating actions are synchronous.

Correspondingly, the middle part of the side board unit 13 is pushed outward, so that when the first side board 131 and the second side board 132 rotate around a rotating shaft of the first side board 131 and the second side board 132 to unfold the side board unit 13, firstly, the first side board 131 and the front board unit 11 rotate around a rotating shaft of the first side board 131 and the front board unit 11, secondly, the second side board 132 and the rear board unit 12 rotate around a rotating shaft of the second side board 132 and the rear board unit 12, thirdly, the bottom board sub-board 142 and the bottom board main board 141 of the bottom board unit 14 rotate around a rotating shaft (a folding shaft) of the bottom board sub-board 142 and the bottom board main board 141 so that the bottom board unit 14 is unfolded, fourthly, the bottom board sub-board 142 of one of the bottom board units 14 and the first side board 131 rotate around a rotating shaft of the bottom board sub-board 142 and the first side board 131, and fifthly, the bottom board sub-board 142 of the other of the bottom board units 14 and the second side board 132 rotate around a rotating shaft of this bottom board sub-board 142 and the second side board 132, so that the storage device 10 may be switched from the folded state to the unfolded state. That is to say, with such one action that the middle part of the side board unit 13 is pushed outward so that the side board unit 13 is unfolded, the storage device 10 may be switched from the folded state to the unfolded state so as to facilitate user operation. It can be understood that all the above rotating actions are synchronous.

Preferably, in this specific example of the cart in the present disclosure, as shown in FIG. 26 to FIG. 33, an included angle is formed between an extension direction of the bottom board main board 141 of the bottom board unit 14 and an extension direction of the bottom board sub-board 142, and a connected position of the bottom board main board 141 and the bottom board sub-board 142 is raised upward.

Specifically, as shown in FIG. 31, an included angle α is formed between a top surface of the bottom board main board 141 and a top surface of the bottom board sub-board 142, and the included angle α is greater than 180°. Correspondingly, an included angle β is formed between a bottom surface of the bottom board main board 141 and a bottom surface of the bottom board sub-board 142, and the included angle β is smaller than 180°. Thus, an included angle is formed between the extension direction of the bottom board main board 141 of the bottom board unit 14 and the extension direction of the bottom board sub-board 142, and a connected position of the bottom board main board 141 and the bottom board sub-board 142 is raised upward. In this manner, when the middle part of the side board unit 13 is pushed in a direction towards the storage cavity 100 of the storage device 10 so that the first side board 131 and the second side board 132 rotate around a rotating shaft of the first side board 131 and the second side board 132, the bottom board sub-board 142 and the bottom board main board 141 can automatically and smoothly rotate around a rotating shaft of the bottom board sub-board 142 and the bottom board main board 141 so as to fold the bottom board unit 14. The situation that the bottom board unit 14 is blocked is avoided to ensure that the storage device 10 is switched from the unfolded state to the folded state.

Preferably, in this specific example of the cart in the present disclosure as shown in FIG. 1A to FIG. 35, when the storage device 10 is in the unfolded state, the main board long side 1413 of the bottom board main board 141 of one of the bottom board units 14 leans against the bottom of the front board unit 11, so that the bottom of the front board unit 11 can support the bottom board main board 141 of this bottom board unit 14 upward. The main board long side 1413 of the bottom board main board 141 of the other of the bottom board units 14 leans against the bottom of the rear board unit 12, so that the bottom of the rear board unit 12 can support the bottom board main board 141 of the bottom board unit 14 upward. The second sub-board short sides 1422 of the two bottom board sub-boards 142 of one of the bottom board units 14 and the second sub-board short sides 1422 of the two bottom board sub-boards 142 of the other of the bottom board units 14 lean against each other. A portion, located between the second sub-board short sides 1422 of the two bottom board sub-boards 142, of the bottom board main board 141 of one of the bottom board units 14 and a portion, located on the second sub-board short sides 1422 of the two bottom board sub-boards 142, of the bottom board main board 141 of the other of the bottom board units 14 lean against each other. In this manner, the bearing capacity of the bottom board unit 14 can be increased. When goods are stored in the storage cavity 100 of the storage device 10, the art can avoid the bottom board unit 14 from being deformed by pressure by means of the goods, so that the reliability of the cart is improved, and the goods can be protected.

It can be understood that the wheels 20 are installed at the bottom of the front board unit 11 and the bottom of the rear board unit 12, resulting in that the bottom board unit 14 is suspended. Therefore, increase in the bearing capacity of the bottom board unit 14 is crucial for the reliability of the cart.

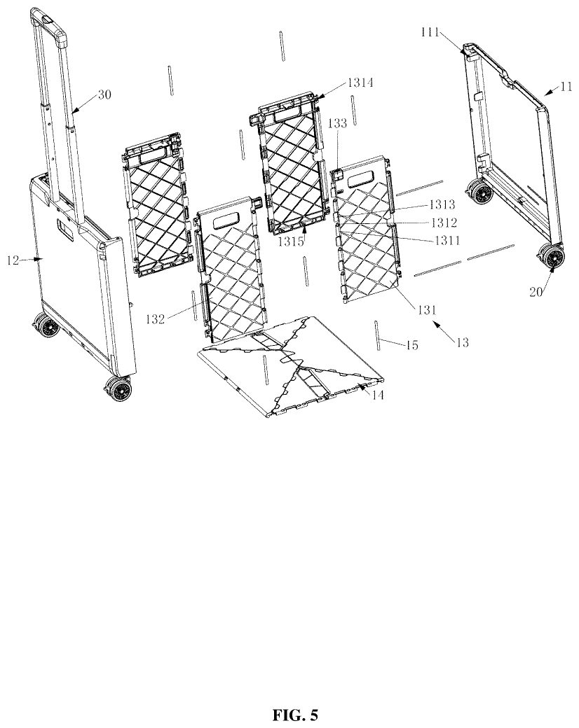

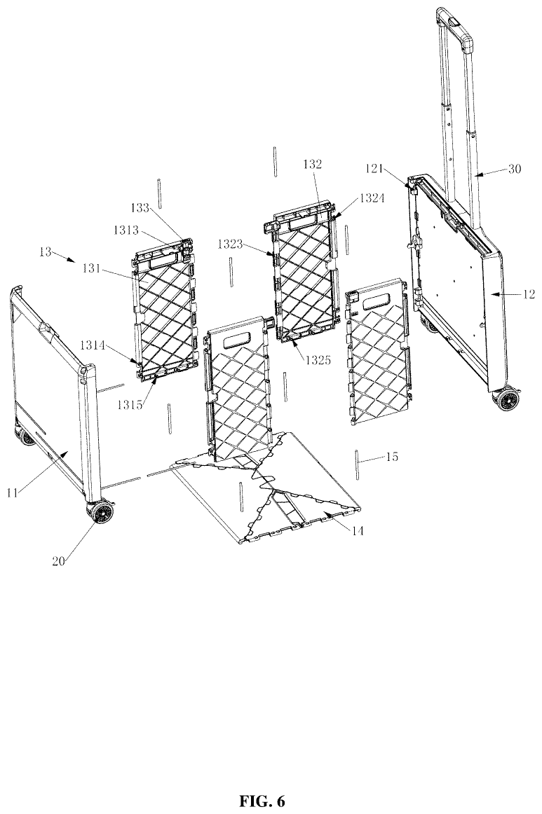

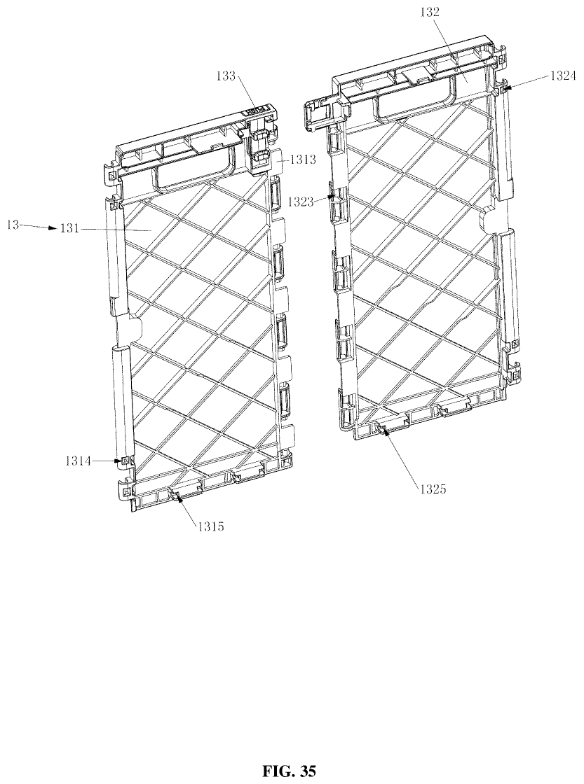

Referring to FIG. 5, FIG. 6, FIG. 34 and FIG. 35, one side of the first side board 131 of the side board unit 13 is provided with a line of shafts 1311 and a pair of pairs of rotating shafts 1312. Each pair of rotating shafts 1312 are arranged at two opposite ends of each of the shafts 1311, respectively. Correspondingly, one side of the second side board 132 is provided with a line of shaft slots 1321 and a plurality of pairs of shaft holes 1322. Each pair of shaft holes 1322 face each of the shaft slots 1321, respectively. Each of the shafts 1311 of the first side board 131 is rotatably arranged in each of the shaft slots 1321 of the second side board 132, respectively. Each of the rotating shafts 1312 of the first side board 131 rotatably extends to each of the shaft holes 1322 of the second side board 132, respectively. In this manner, one side of the first side board 131 and one side of the second side board 132 are connected by a shaft, so that the middle part of the side board unit 13 is foldable.

Preferably, one side of the first side board 131 of the side board unit 13 is provided with a line of blocking tables 1313. The blocking table 1313 is adjacent to the shaft 1311. Correspondingly, one side of the second side board 132 is provided with a row of side board grooves 1323. The side board groove 1323 is adjacent to the shaft slot 1321. When the storage device 10 is in the unfolded state, each of the blocking tables 1313 of the first side board 131 extends to each of the side board grooves 1323 of the second side board 132, respectively. In this manner, when the goods stored in the storage cavity 100 of the storage device 10 pushes the middle part of the side board unit 13 outward, the blocking table 1313 of the first side board 131 and an inner wall, used for forming the side board groove 1323, of the second side board 132 interact with each other to avoid relative rotation of the first side board 131 and the second side board 132, so that the reliability and stability of the cart are improved. That is to say, after the side board unit 13 is unfolded, the blocking table 1313 of the first side board 131 and an inner wall, used for forming the side board groove 1323, of the second side board 132 interact with each other, so that the side board unit 13 is foldable inward only.

Referring to FIG. 5, FIG. 6, FIG. 34 and FIG. 35, the side board unit 13 further includes a locking device 133. After the first side board 131 and the second side board 132 are unfolded, the locking device 133 is used for locking the first side board 131 and the second side board 132 to avoid the first side board 131 and the second side board 132 from rotating uncontrollably around the rotating shaft of the first side board 131 and the second side board 132. In this manner, the storage device 10 can be stably kept in the unfolded state.

It is worth mentioning that the specific structure of the locking device 133 and the connected relation of the locking device 133, the first side board 131 and the second side board 132 are recorded in a patent documentation (TWM659149U) of Taiwan Province in China, and the present disclosure will not be repeatedly described here.

Referring to FIG. 5, FIG. 6, FIG. 34 and FIG. 35, two opposite sides of the front board unit 11 are respectively provided with at least one front board shaft hole 111. One side, away from the second side board 132, of the first side board 131 is provided with at least one first lateral shaft hole 1314. The position of the front board shaft hole 111 of the front board unit 11 corresponds to the position of the first lateral shaft hole 1314 of the first side board 131 in a height direction. The storage device 10 further includes a plurality of assembly shafts 15. One part of the assembly shaft 15 is inserted in the front board shaft hole 111 of the front board unit 11, and the other part of the assembly shaft 15 is inserted in the first lateral shaft hole 1314 of the first side board 131, so that the front board unit 11 and the first side board 131 are connected by a shaft.

In one specific example of the cart in the present disclosure, the top and the bottom of each side of the front board unit 11 are provided with at least one of the front board shaft holes 111, respectively. The top and the bottom of one side, away from the second side board 132, of the first side board 131 are provided with at least one first lateral shaft hole 1314, respectively. Thus, one of the assembly shafts 15 is connected to the front board unit 11 and the first side board 131 at a top shaft, and the other of the assembly shafts 15 is connected to the front board unit 11 and the first side board 131 at a bottom shaft, so that the stability and reliability of the cart are improved.

Continuing to refer to FIG. 5, FIG. 6, FIG. 34 and FIG. 35, two opposite sides of the rear board unit 12 are provided with at least one rear board shaft hole 121, respectively. One side, away from the first side board 131, of the second side board 132 is provided with at least one second lateral shaft hole 1324. The position of the rear board shaft hole 121 of the rear board unit 12 corresponds to the position of the second lateral shaft hole 1324 of the second side board 132 in a height direction. One part of the assembly shaft 15 is inserted in the rear board shaft hole 121 of the rear board unit 12, and the other part of the assembly shaft 15 is inserted in the second lateral shaft hole 1324 of the second side board 132, so that the rear board unit 12 and the second side board 132 are connected by a shaft.

In one specific example of the cart in the present disclosure, the top and the bottom of each side of the rear board unit 12 are provided with at least one of the rear board shaft holes 121, respectively. The top and the bottom of one side, away from the first side board 131, of the second side board 132 are provided with at least one second lateral shaft hole 1324, respectively. Thus, one of the assembly shafts 15 is connected to the rear board unit 12 and the second side board 132 at a top shaft, and the other of the assembly shafts 15 is connected to the rear board unit 12 and the second side board 132 at a bottom shaft, so that the stability and reliability of the cart are improved.

Referring to FIG. 5, FIG. 6, and FIG. 26 to FIG. 33, the bottom board sub-board 142 is provided with at least one first sub-board shaft hole 1424 in the first sub-board short side 1421. The bottom of the first side board 131 is provided with at least one first bottom shaft hole 1315. The bottom of the second side board 132 is provided with at least one second bottom shaft hole 1325. One part of one of the assembly shafts 15 is inserted in the first sub-board shaft hole 1424 of one of the bottom board sub-boards 142, and the other part of each of the assembly shafts 15 is inserted in the first bottom shaft hole 1325 of one of the first side board 131. Thus, the first sub-board short side 1421 of the bottom board sub-board 142 and the bottom of the first side board 131 are connected by a shaft. One part of the other of the assembly shafts 15 is inserted in the first sub-board shaft hole 1424 of the other of the bottom board sub-boards 142, and the other part of the other of the assembly shafts 15 is inserted in the second bottom shaft hole 1325 of the second side board 132. Thus, the first sub-board short side 1421 of the bottom board sub-board 142 and the bottom of the second side board 132 are connected by a shaft.

Referring to FIG. 5, FIG. 6, and FIG. 26 to FIG. 33, the bottom board main board 141 is provided with at least one main board shaft hole 1414 in the first main board short side 1411 and the second main board short side 1412, respectively. The bottom board sub-board 142 is provided with at least one second sub-board shaft hole 1425 in the sub-board long side 1423. One part of one of the assembly shafts 15 is inserted in the main board shaft hole 1414 of the first main board short side 1411 of the bottom board main board 141, and the other part of one of the assembly shafts 15 is inserted in the second sub-board shaft hole 1425 of one of the bottom board sub-boards 142. Thus, the sub-board long side 1423 of this bottom board sub-board 142 and the first main board short side 1411 of the bottom board main board 141 are connected by a shaft. One part of the other of the assembly shafts 15 is inserted in the main board shaft hole 1414 of the second main board short side 1412 of the bottom board main board 141, and the other part of the other of the assembly shafts 15 is inserted in the second sub-board shaft hole 1425 of the other of the bottom board sub-boards 142. Thus, the sub-board long side 1423 of this bottom board sub-board 142 and the first main board short side 1411 of the bottom board main board 141 are connected by a shaft.

Continuing to refer to FIG. 5, FIG. 6, and FIG. 26 to FIG. 31, the bottom board main board 141 is provided with at least one first main board leaning buckle 1415 and at least one first main board leaning slot 1416 on the first main board short side 1411 and the second main board short side 1412, respectively. The first main board leaning buckle 1415 and the first main board leaning slot 1416 are staggered mutually. The bottom board sub-board 142 is provided with at least one first sub-board leaning buckle 1426 and at least one first sub-board leaning slot 1427 on the sub-board long side 1423, respectively. The first sub-board leaning buckle 1426 and the first sub-board leaning slot 1427 are staggered mutually. When the storage device 10 is in the unfolded state so that the bottom board unit 14 is unfolded, the first main board leaning buckle 1415 of the bottom board main board 141 leans against the bottom board sub-board 142 and is accommodated in the first sub-board leaning slot 1427 of the bottom board sub-board 142. The first sub-board leaning buckle 1426 of the bottom board sub-board 142 leans against the bottom board main board 141 and is accommodated in the first main board leaning slot 1416 of the bottom board main board 141. In this manner, the cart can avoid relative rotation of the bottom board main board 141 and the bottom board sub-board 142, so that the bearing capacity of the bottom board unit 14 and the reliability and stability of the cart are improved. At the same time, the cart can enable the bottom board unit 14 to provide a relatively smooth bearing surface.

Preferably, the bottom board main board 141 is provided with a first main board buckle body 14151 at the first main board leaning buckle 1415. The first main board leaning slot 1416 of the bottom board main board 141 is provided with a first main board buckle slot 14161. The bottom board sub-board 142 is provided with a first sub-board buckle body 14261 at the first sub-board leaning buckle 1426. The first sub-board leaning slot 1427 of the bottom board sub-board 142 is provided with a first sub-board buckle slot 14271. The first main board buckle body of the first main board leaning buckle is capable of being buckled in the first sub-board buckle slot of the bottom board sub-board, and the first sub-board buckle body of the first sub-board leaning buckle is capable of being buckled in the first main board buckle slot of the bottom board main board. When the first main board leaning buckle 1415 of the bottom board main board 141 leans against the bottom board sub-board 142 and is accommodated in the first sub-board leaning slot 1427 of the bottom board sub-board 142, the first main board buckle body 14151 of the first main board leaning buckle 1415 is buckled in the first sub-board buckle slot 14271 of the bottom board sub-board 142. Correspondingly, when the first main board leaning buckle 1426 of the bottom board sub-board 142 leans against the bottom board main board 141 and is accommodated in the first main board leaning slot 1416 of the bottom board main board 141, the first sub-board buckle body 14261 of the first sub-board leaning buckle 1426 is buckled in the first main board buckle slot 14161 of the bottom board main board 141. In this manner, the cart can further provide the bearing capacity of the bottom board unit 14.

Continuing to refer to FIG. 5, FIG. 6, and FIG. 26 to FIG. 33, the bottom board sub-board 142 is provided with at least one second sub-board leaning buckle 1428 and at least one second sub-board leaning slot 1429 at the second sub-board short side 1422. The second sub-board leaning buckle 1428 and the second sub-board leaning slot 1429 are staggered mutually. When the storage device 10 is in the unfolded state so that the bottom board unit 14 is unfolded, the second sub-board leaning buckle 1428 of the bottom board sub-board 142 of one of the bottom board units 14 leans against the bottom board sub-board 142 of the other of the bottom board units 14 and is accommodated in the second sub-board leaning slot 1429, so that the second sub-board short sides 1422 of the two bottom board sub-boards 142 of one of the bottom board units 14 and the second sub-board short sides 1422 of the two bottom board sub-boards 142 of the other of the bottom board units 14 lean against each other. Thus, the bearing capacity of the bottom board unit 14 is increased, and the reliability and stability of the cart are improved. At the same time, the cart can enable the bottom board unit 14 to provide a relatively smooth bearing surface.

Continuing to refer to FIG. 5, FIG. 6, and FIG. 26 to FIG. 33, a portion, located between the second sub-board short sides 1422 of the two bottom board sub-boards 142, of the bottom board main board 141 is provided with at least one second main board leaning buckle 1417 and at least one second main board leaning slot 1418. When the storage device 10 is in the unfolded state so that the bottom board unit 14 is unfolded, the second main board leaning buckle 1417 of the bottom board main board 141 of one of the bottom board units 14 leans against the bottom board main board 141 of the other of the bottom board units 14 and is accommodated in the second main board leaning slot 1418 of this bottom board main board 141, so that a portion, located between the second sub-board short sides 1422 of the two bottom board sub-boards 142, of the bottom board main board 141 of one of the bottom board units 14 and a portion, located between the second sub-board short sides 1422 of the two bottom board sub-boards 142, of the bottom board main board 141 of the other of the bottom board units 14 lean against each other. In this manner, the cart can increase the bearing capacity of the bottom board unit 14, and the reliability and stability of the cart are improved. At the same time, the cart can enable the bottom board unit 14 to provide a relatively smooth bearing surface.

Preferably, the second main board leaning buckle 1417 of the bottom board main board 141 is provided with a first second main board buckle body 14171. The second main board leaning slot 1418 of the bottom board main board 141 is provided with a second main board buckle slot 14181. When the second main board leaning buckle 1417 of the bottom board main board 141 of one of the bottom board units 14 leans against the bottom board main board 141 of the other of the bottom board units 14 and is accommodated in the second main board leaning slot 1418 of this bottom board main board 141, the second main board buckle body 14171 of the second main board leaning buckle 1417 is buckled in the second main board buckle slot 14181 of the other of the bottom board main boards 141. In this manner, the cart can avoid the two bottom board units 14 from getting away from each other to prevent from generating a gap between the two bottom board units 14, so that the bearing capacity of the bottom board unit 14 is increased, and the reliability and stability of the cart are improved.

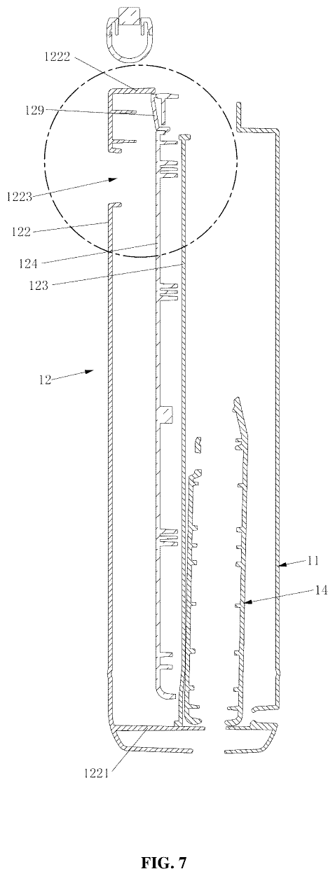

Referring to FIG. 7 to FIG. 25, the front board unit 11 is provided with at least one locking protrusion 112. The rear board unit 12 includes a rear board main body 122, a baffle 123, an unlocking board 124, at least one leaf spring 125, at least one locking hook 126 and at least one locking spring 127. The baffle 123 is installed on the inner side of the rear board main body 122. The unlocking board 124 is removably arranged between the rear board main body 122 and the baffle 123. The leaf spring 125 is configured to have one end keeping still relative to a bottom edge 1221 of the rear board main body 122 and the other end abutting against the bottom of the unlocking board 124. The leaf spring 125 is used for pushing the unlocking board 124 to move upward in the process of recovering an initial state. The locking hook 126 is rotatably installed on the baffle 123 and drivably connected to the unlocking board 124. The locking hook 126 is capable of hooking the locking protrusion 112 of the front board unit 11. The locking spring 127 is configured to have one end abutting against the baffle 123 and the other end abutting against the locking hook 126. The locking spring 127 is used for keeping the locking hook 126 at a position that the locking protrusion 112 of the front board unit 11 is hooked. It can be understood that when the locking hook 126 of the rear board unit 12 hooks the locking protrusion 112 of the front board unit 11, the rear board unit 12 locks the front board unit 11 to avoid the front board unit 11 and the rear board unit 12 from relatively moving uncontrollably and ensure that the storage device 10 is stably kept in the folded state. When the locking hook 126 of the rear board unit 12 releases the locking protrusion 112 of the front board unit 11, the rear board unit 12 releases the front board unit 11, and the front board unit 11 and the rear board unit 12 are allowed to move relatively, so that the storage device 10 can be switched from the folded state to the unfolded state. In addition, after the storage device 10 is switched to the unfolded state, the unlocking board 124 can be drawn out between the rear board main body 122 and the baffle 123, and four edges of the unlocking board 124 can be supported by the top of the front board unit 11, the tops of the two side board units 13 and the top of the baffle 123, respectively, so that the unlocking board 124 can form a cover to cover a cavity opening of the storage cavity 100 of the storage device 10, as shown in FIG. 1A.

In one specific example of the cart in the present disclosure as shown in FIG. 1A to FIG. 35, middle parts of two opposite sides of the front board unit 11 are provided with one of the locking protrusions 112, respectively. Middle parts of two opposite sides of the baffle 123 of the rear board unit 12 are provided with one of the locking hooks 126, respectively. Thus, the two locking hooks 126 of the rear board unit 12 can hook the two locking protrusions 112 of the front board unit 11, respectively, so that the rear board unit 12 reliably locks the front board unit 11 to ensure that the storage device 10 is stably kept in the folded state.

Preferably, the two locking hooks 126 of the rear board unit 12 are drivably connected to two opposite sides of the unlocking board 124. Thus, when the unlocking board 124 is pushed to move upward by the leaf spring 125, the unlocking board 124 can drive the two locking hooks 126 to rotate at the same time, so that the two locking hooks 126 release the two locking protrusions 112 of the front board unit 11 at the same time.

In this specific example of the cart in the present disclosure as shown in FIG. 1A to FIG. 35, the number of the leaf springs 125 of the rear board unit 12 is two. The two leaf springs 125 are arranged on two opposite sides of the bottom of the baffle 123, respectively. Thus, the unlocking board 124 can be avoided from being inclined when the two leaf springs 125 push the unlocking board 124 to move upward.

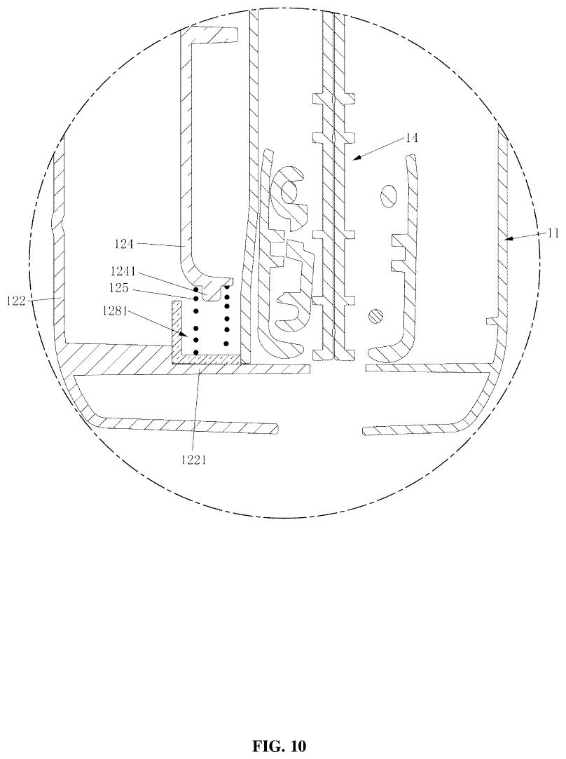

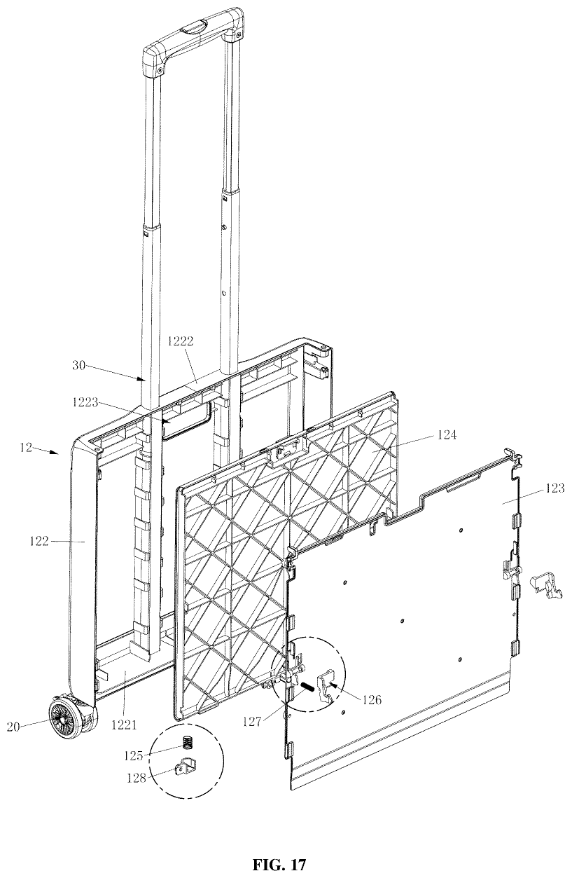

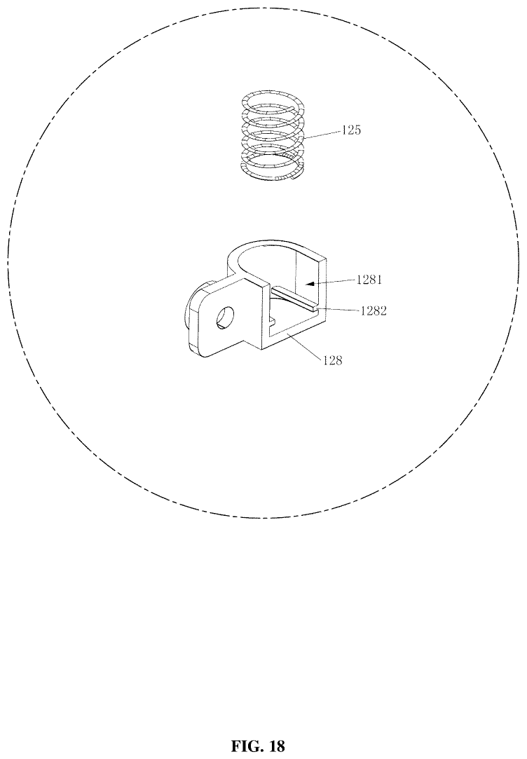

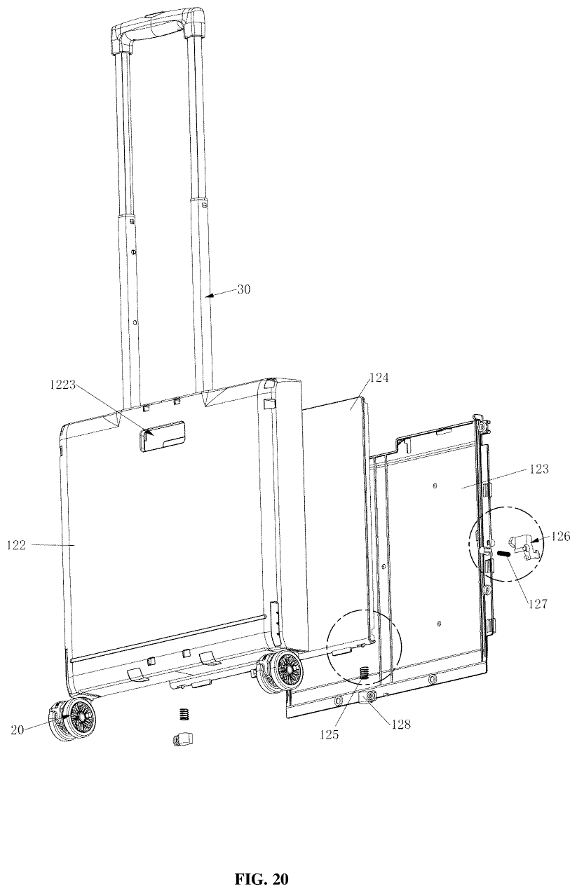

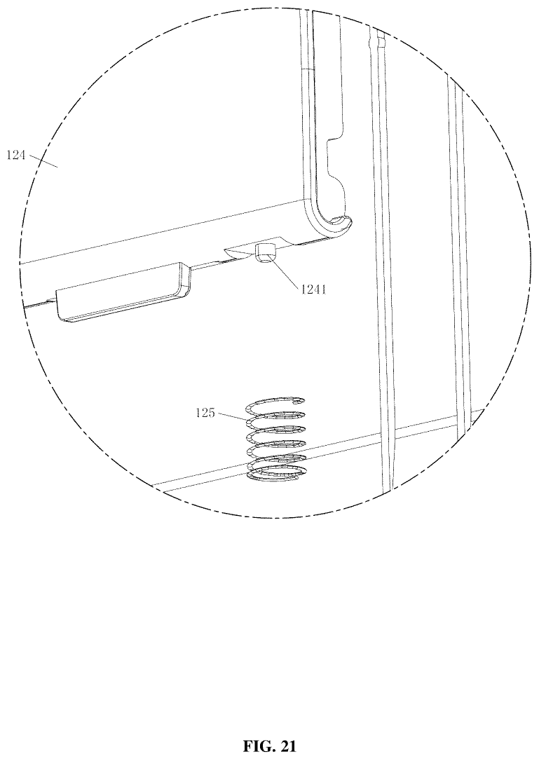

Referring to FIG. 9, FIG. 10, FIG. 17, FIG. 18, FIG. 20 and FIG. 21, the rear board unit 12 further includes a spring seat 128. The bottom of the leaf spring 125 is installed at the spring seat 128. The spring seat 128 is installed at the rear board main body 122. Thus, the bottom of the leaf spring 125 is configured to remain unchanged relative to the position of the rear board main body 122. Preferably, the spring seat 128 is provided with a seat slot 1281 and two raised ribs 1282. The two raised ribs 1282 are raised into the seat slot 1281 on two opposite sides of the seat slot 1281, respectively. The bottom of the leaf spring 125 sinks to the seat slot 1281 of the spring seat 128, and the two raised ribs 1282 of the spring seat 128 stretch into a gap in the bottom of the leaf spring 125, respectively, so that the bottom of the leaf spring 125 is installed at the spring seat 128. In one specific example of the cart in the present disclosure, the spring seat 128 can be installed at the rear board unit 12 with screws.

Preferably, the bottom of the unlocking board 124 is provided with at least one board column 1241. The board column 1241 extends to the bottom of the leaf spring 125 on the top of the leaf spring 125 to avoid the top of the leaf spring 125 from being staggered relative to the bottom of the unlocking board 124, so that the top of the leaf spring 12 stably abuts against the bottom of the unlocking board 124.

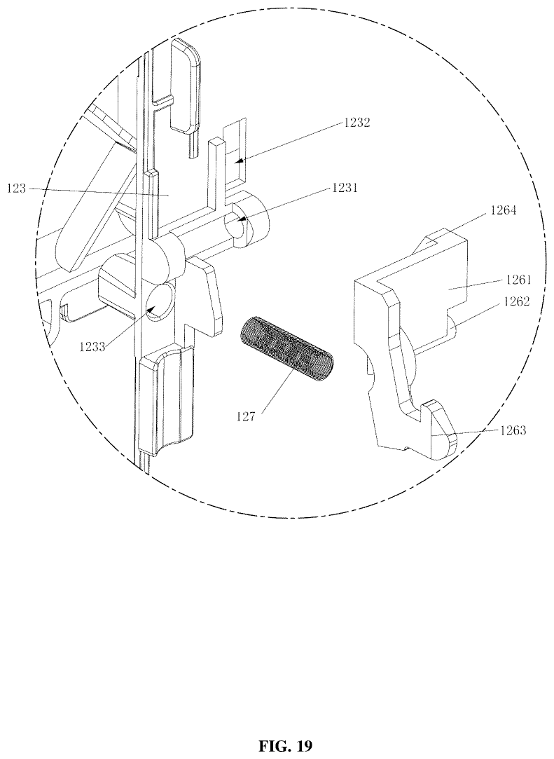

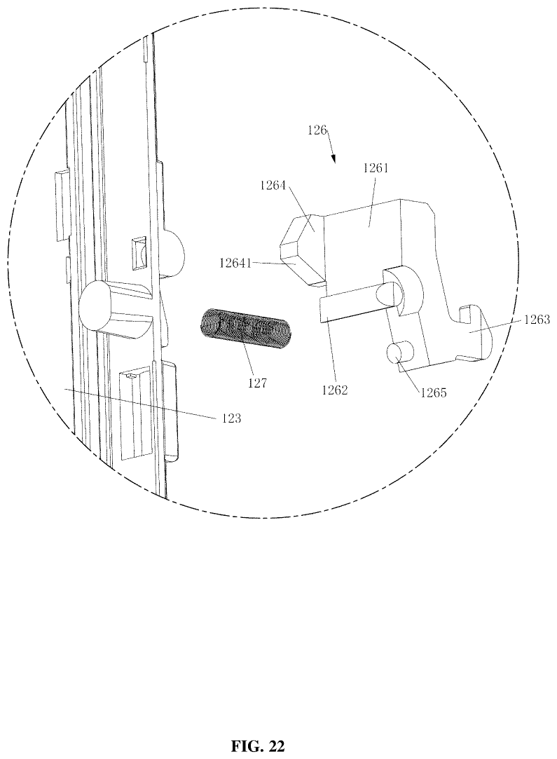

Referring to FIG. 19 and FIG. 22, the locking hook 126 includes a lock body 1261, a pivotal axis 1262, a hook body 1263 and a driven block 1264. The pivotal axis 1262 is arranged at the bottom of the lock body 1261. The hook body 1263 is arranged in front of the lock body 1261, and the driven block 1264 is arranged at the back of the lock body 1261. The driven block 1264 is provided with a driven inclined plane 12641. Preferably, the locking hook 126 is of a one-piece structure.

A side of the unlocking board 124 is provided with at least one driving block 1242. The driving block 1242 is provided with a driving inclined plane 12421. The baffle 123 is provided with a pair of pivotal holes 1231 and a baffle channel 1232 adjacent to the pivotal holes 1231. The baffle channel 1232 of the baffle 123 corresponds to the driving block 1242 of the unlocking board 124 in a horizontal direction. Two opposite ends of the pivotal axis 1262 of the locking hook 126 are rotatably installed in the pair of pivotal holes 1231 of the baffle 123, respectively. The driven block 1264 extends to the driving block 1242 of the unlocking board 124 through the baffle channel 1232 of the baffle 123, and the driven inclined plane 12641 of the driven block 1264 is laminated to the driving inclined plane 12421 of the driving block 1242. An end of the locking spring 127 abuts against the bottom of the hook body 163 of the locking hook 1263.

Preferably, the locking hook 126 further includes a locking column 1265. The locking column 1265 is arranged at the bottom of the hook body 1263. The locking column 1265 extends to the interior of the locking spring 127 at one end of the locking spring 127 to avoid this end of the locking spring 127 from sliding relative to the hook body 1263, so that the end of the locking spring 127 stably abuts against the hook body 1263.

Preferably, a side of the baffle 123 is provided with at least one accommodation hole 1233. The accommodation hole 1233 is located at the back of the hook body 1263 of the locking hook 126. One end of the locking spring 127 is accommodated in the accommodation hole 1233 of the baffle 123. Thus, this end of the locking spring 127 can stably abut against the baffle 123 to avoid this end of the locking spring 127 from sliding relative to the baffle 123.

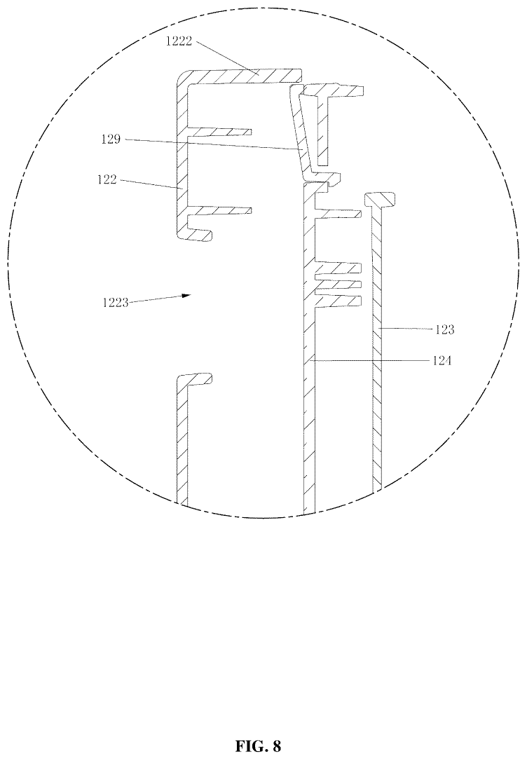

Continuing to refer to FIG. 7 and FIG. 8, the rear board unit 12 further includes a blocked part 129. The blocked part 129 is arranged on the top of the unlocking board 124, wherein the blocked part 129 is capable of being blocked or released by a top edge 1222 of the rear board main body 122. When the blocked part 129 is blocked by the top edge 1222 of the rear board main body 122, the unlocking board 124 and the rear board main body 122 are matched with each other so that the leaf spring 125 is in a compressed state and the unlocking board 124 is blocked from generating upward movement relative to the rear board main body 122. When the blocked part 129 is released by the top edge 1222 of the rear board main body 122, the leaf spring 125 pushes the unlocking board 124 to move upward in the process of recovering an initial state.

In one specific example of the cart in the present disclosure, the blocked part 129 can be released by the top edge 1222 of the rear board main body 122 by pushing the blocked part 129 to move in a direction towards the baffle 123. Referring to FIG. 3, FIG. 7 and FIG. 8, the rear board main body 122 is provided with an operation channel 1223. A part, adjacent to the blocked part 129, of the unlocking board 124 corresponds to the operation channel 1223 of the rear board main body 122. When a user applies thrust by means of the operation channel 1223 of the rear board main body 122 to the top of the unlocking board 124 to move or deform in a direction close to the baffle 123, the unlocking board 124 drives the blocked part 129 to move towards the direction close to the baffle 123, so that the top edge 1222 of the rear board main body 122 releases the blocked part 129. Optionally, in other specific examples of the cart in the present disclosure, the blocked part 129 can also directly align to the operation channel 1223 of the rear board main body 122, so that the user can directly apply thrust to the blocked part 129 by means of the operation channel 1223 of the rear board main body 122, so that the blocked part 129 can move towards the direction of the baffle 123 and be released by the top edge 1222 of the rear board main body 122.

It can be understood that since the blocked part 129 can be operated only by means of the operation channel 1223 of the rear board main body 122, the storage device 10 can be stably kept in the folded state when the user normally carries or transports the storage device 10 in the folded state.

It is worth mentioning that the specific manner that the blocked part 129 is arranged on the top of the unlocking board 124 is not limited in the cart in the present disclosure. For example, in this specific example of the cart as shown in FIG. 1A to FIG. 35, the blocked part 129 is fixedly installed on the top of the unlocking board 124. Optionally, in other specific examples of the cart in the present disclosure, the blocked part 129 and the unlocking board 124 are of a one-piece structure.

Referring to FIG. 1A and FIG. 1B, when the storage device 10 is in the unfolded state, each of the side board units 13 and each of the bottom board units 14 are unfolded, so that the front board unit 11, the rear board unit 12, each of the side board units 13 and each of the bottom board units 14 are enclosed to form the storage cavity 100. At this time, the hook body 1263 of the locking hook 126 is located in an avoidance slot 1326 of the second side board 132 of the side board unit 13. The main board long side 1413 of the bottom board main board 141 of one of the bottom board units 14 leans against the bottom of the front board unit 11, and the main board long side 1413 of the bottom board main board 141 of the other of the bottom board units 14 leans against the bottom of the rear board unit 12. The first main board leaning buckle 1415 of the bottom board main board 141 leans against the bottom board sub-board 142 and is accommodated in the first sub-board leaning slot 1427 of the bottom board sub-board 142. The first sub-board leaning buckle 1426 of the bottom board sub-board 142 leans against the bottom board main board 141 and is accommodated in the first main board leaning slot 1416 of the bottom board main board 141. The second sub-board leaning buckle 1428 of the bottom board sub-board 142 of one of the bottom board units 14 leans against the bottom board sub-board 142 of the other of the bottom board units 14 and is accommodated in the second sub-board leaning slot 1429. The second main board leaning buckle 1417 of the bottom board main board 141 of one of the bottom board units 14 leans against the bottom board main board 141 of the other of the bottom board units 14 and is accommodated in the second main board leaning slot 1418 of this bottom board main board 141.

Referring to FIG. 3, FIG. 4, FIG. 7, FIG. 9 and FIG. 11, when the storage device 10 is in the folded state, each of the side board units 13 and each of the bottom board units 14 are folded and clamped between the front board unit 11 and the rear board unit 12. The blocked part 129 is blocked by the top edge 1222 of the rear board main body 122. The bottom edge 1221 of the rear board main body 122 of the unlocking board 124 compresses the leaf spring 125 so that the leaf spring 125 is kept in a compressed state. The hook body 1263 of the locking hook 126 hooks the locking protrusion 112 of the front board unit 11.

In the process that the storage device 10 is switched to the folded state from the unfolded state, the middle part of the side board unit 13 is pushed in a direction towards the storage cavity 100 of the storage device 10, so that the first side board 131 and the second side board 132 rotate around a rotating shaft of the first side board 131 and the second side board 132 to fold the side board unit 13 inward. At the same time, the first side board 131 and the front board unit 11 rotate around a rotating shaft of the first side board 131 and the front board unit 11. The second side board 132 and the rear board unit 12 rotate around a rotating shaft of the second side board 132 and the rear board unit 12. The bottom board sub-board 142 and the bottom board main board 141 of the bottom board unit 14 rotate around a rotating shaft (a folding shaft) of the bottom board sub-board 142 and the bottom board main board 141 so that the bottom board unit 14 is folded upward. The bottom board sub-board 142 of one of the bottom board units 14 and the first side board 131 rotate around a rotating shaft of the bottom board sub-board 142 and the first side board 131. The bottom board sub-board 142 of the other of the bottom board units 14 and the second side board 132 rotate around a rotating shaft of this bottom board sub-board 142 and the second side board 132. The front board unit 11 and the rear board unit 12 get close to each other. When the front board unit 11 is overlapped on the rear board unit 12, the hook body 1263 of the locking hook 126 hooks the locking protrusion 112 of the front board unit 11, so that the rear board unit 12 locks the front board unit 11, and the storage device 10 is kept in the folded state.

In the process that the storage device 10 is switched to the unfolded state from the folded state, when thrust is applied by means of the operation channel 1223 of the rear board main body 122 to the top of the unlocking board 124, so that the top of the unlocking board 124 moves or deforms in a direction towards the baffle 123. The unlocking board 124 drives the blocked part 129 to move in a direction towards the baffle 123, so that the top edge 1222 of the rear board main body 122 releases the blocked part 129. And then, the leaf spring 125 pushes the unlocking board 124 to move upward in the process of recovering an initial state. The driving block 1242 of the unlocking board 124 and the driven block 1264 of the locking hook 126 coordinate with each other, so that the locking hook 126 rotates to allow the hook body 1263 of the locking hook 126 from being separated away from the locking protrusion 112 of the front board unit 11. At this time, the rear board unit 12 releases the front board unit 11. Subsequently, when the front board unit 11 and the rear board unit 12 get away from each other by pulling the front board unit 11 and the rear board unit 12, each of the side board units 13 and each of the bottom board units 14 are unfolded to allow the storage device 10 to be switched to the unfolded state.

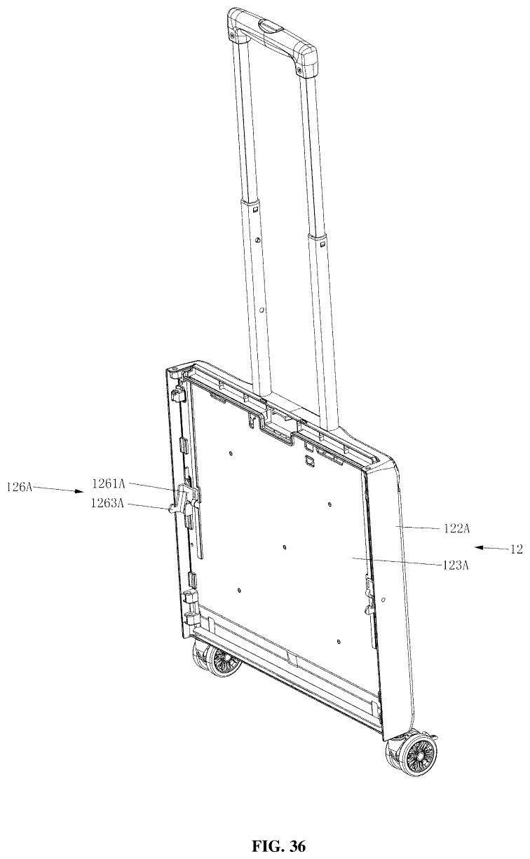

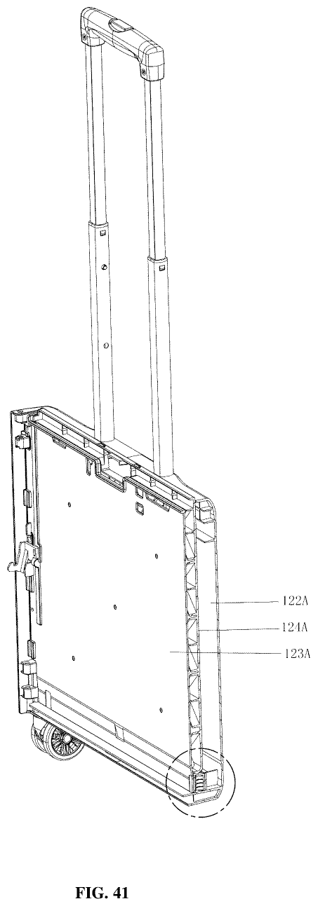

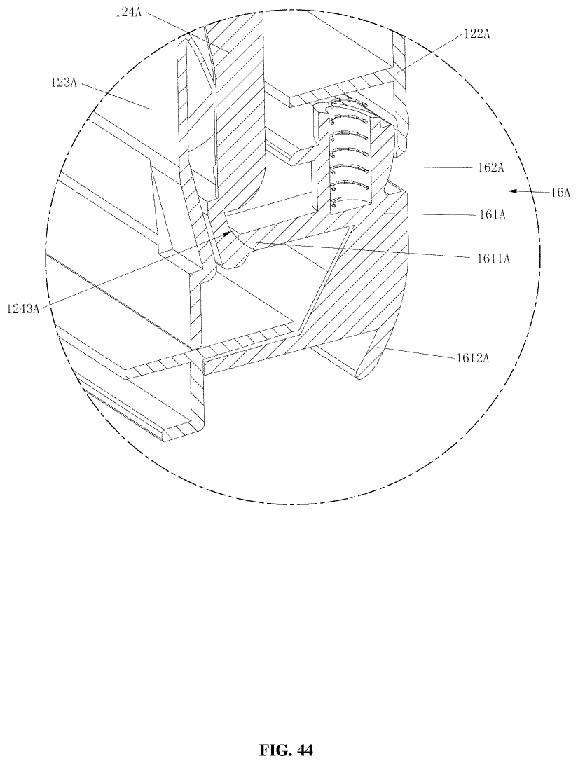

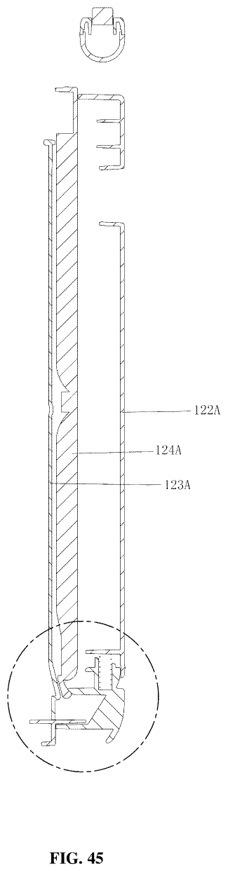

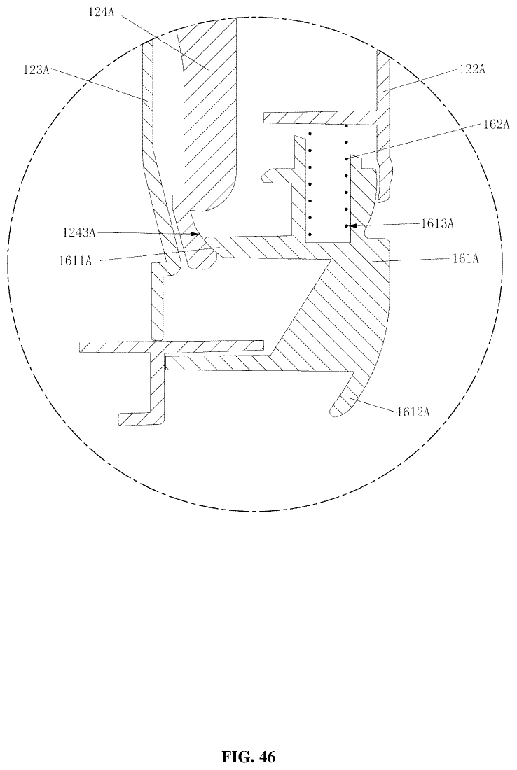

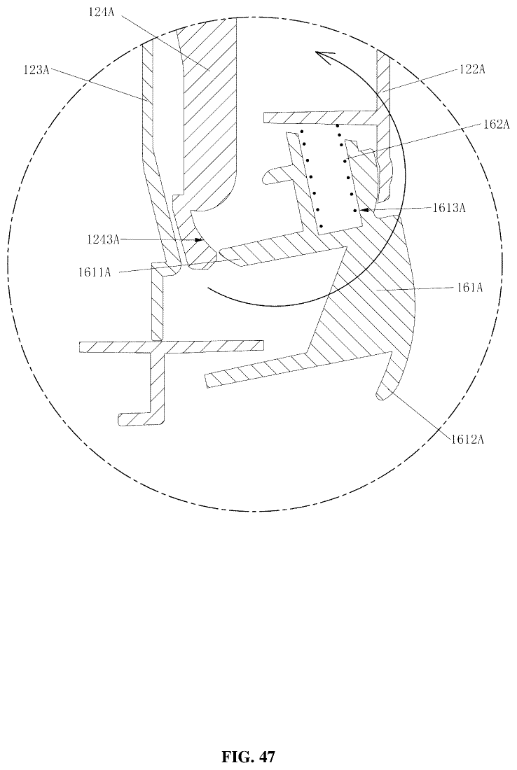

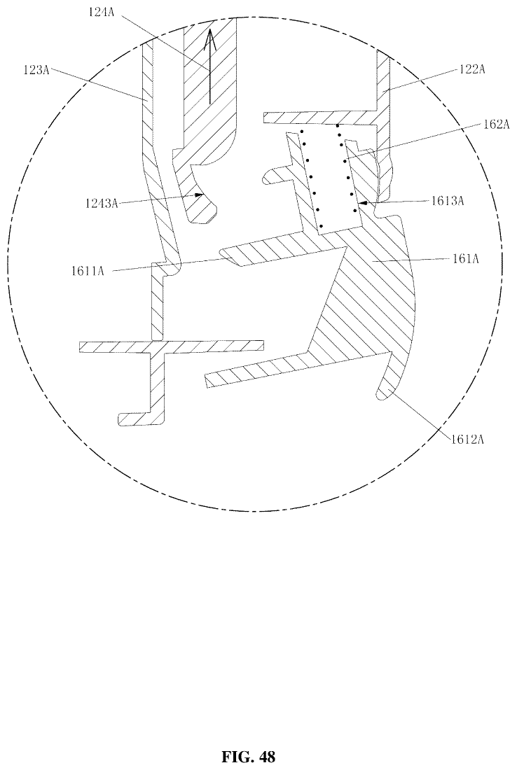

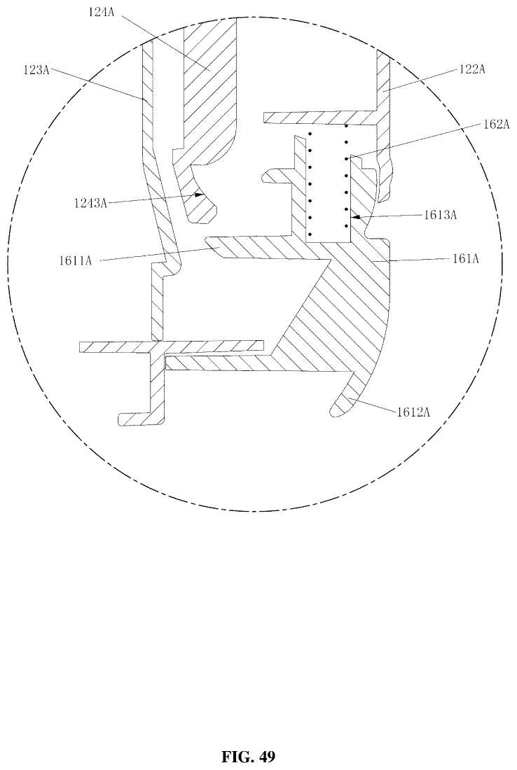

The difference between one deformation example of the cart in the present disclosure as shown in FIG. 36 to FIG. 49 and the cart as shown in FIG. 1 to FIG. 35 lies in that the rear board unit 12 of the storage device 10 of the cart as shown in FIG. 36 to FIG. 49 includes a rear board main body 122A, a baffle 123A, an unlocking board 124A, at least one leaf spring 125A, at least one locking hook 126A and at least one locking spring 127A. The baffle 123A is installed on the inner side of the rear board main body 122A. The unlocking board 124A is removably arranged between the rear board main body 122A and the baffle 123A. The leaf spring 125A is configured to have one end keeping still relative to a bottom edge 1221A of the rear board main body 122A and the other end abutting against the bottom of the unlocking board 124A. The leaf spring 125A is used for pushing the unlocking board 124A to move upward in the process of recovering an initial state. The locking hook 126A is capable of hooking the locking protrusion 112 of the front board unit 11. The locking spring 127A is configured to have one end abutting against the baffle 123A and the other end abutting against the locking hook 126A. The locking spring 127A is used for keeping the locking hook 126A to a position that the locking protrusion 112 of the front board unit 11 is hooked. It can be understood that when the locking hook 126A of the rear board unit 12 hooks the locking protrusion 112 of the front board unit 11, the rear board unit 12 locks the front board unit 11 to avoid the front board unit 11 and the rear board unit 12 from relatively moving uncontrollably and ensure that the storage device 10 is stably kept in the folded state. When the locking hook 126A of the rear board unit 12 releases the locking protrusion 112 of the front board unit 11, the rear board unit 12 releases the front board unit 11, and the front board unit 11 and the rear board unit 12 are allowed to move relatively, so that the storage device 10 can be switched from the folded state to the unfolded state. In addition, after the storage device 10 is switched to the unfolded state, the unlocking board 124A can be drawn out between the rear board main body 122A and the baffle 123A, and four edges of the unlocking board 124A can be supported by the top of the front board unit 11, the tops of the two side board units 13 and the top of the baffle 123A, respectively, so that the unlocking board 124A can form a cover to cover a cavity opening of the storage cavity 100 of the storage device 10.

In one specific example of the cart in the present disclosure, middle parts of two opposite sides of the baffle 123A of the rear board unit 12 are provided with one of the locking hooks 126A, respectively. Thus, the two locking hooks 126A of the rear board unit 12 can hook the two locking protrusions 112 on two opposite sides of the front board unit 11, respectively, so that the rear board unit 12 reliably locks the front board unit 11 to ensure that the storage device 10 is stably kept in the folded state.

Preferably, the two locking hooks 126A of the rear board unit 12 are drivably connected to two opposite sides of the unlocking board 124A. Thus, when the unlocking board 124A is pushed to move upward by the leaf spring 125A, the unlocking board 124A can drive the two locking hooks 126A to rotate at the same time, so that the two locking hooks 126A release the two locking protrusions 112 of the front board unit 11 at the same time.

In this specific example of the cart in the present disclosure as shown in FIG. 36 to FIG. 49, the number of the leaf springs 125A of the rear board unit 12 is two. The two leaf springs 125A are arranged on two opposite sides of the bottom of the baffle 123A, respectively. Thus, the unlocking board 124A can be avoided from being inclined when the two leaf springs 125 push the unlocking board 124A to move upward.

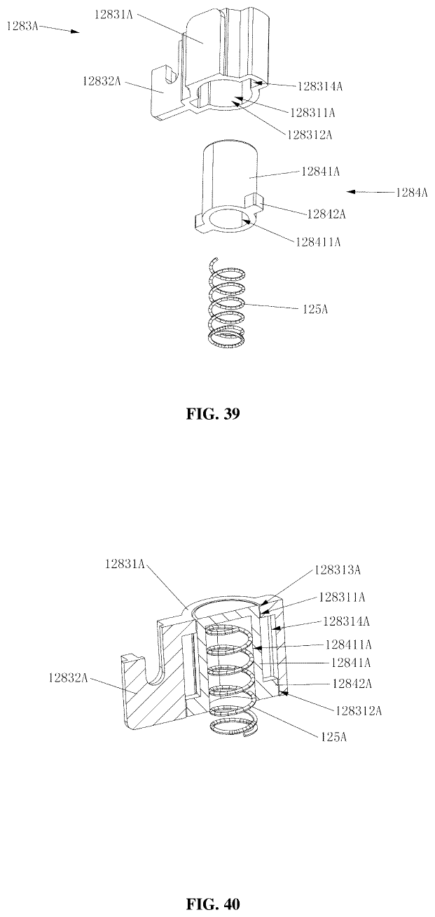

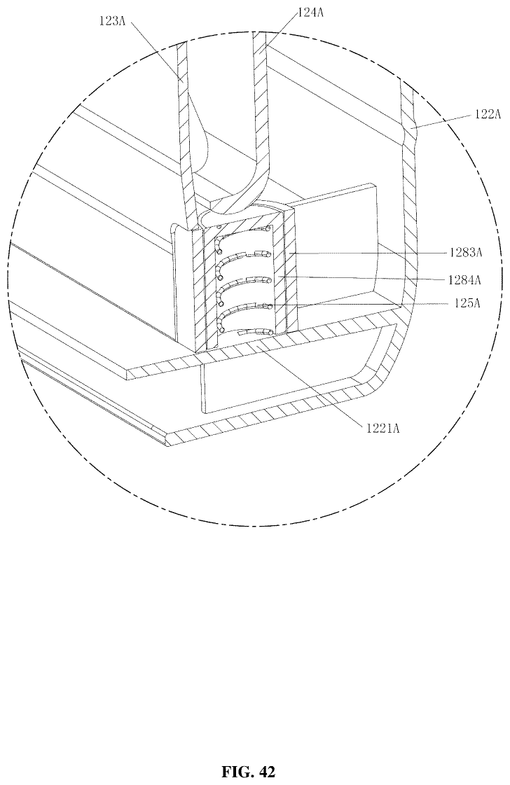

Referring to FIG. 39, FIG. 40 and FIG. 42, the rear board unit 12 further includes a spring seat 128A. The spring seat 128 includes a fixed seat 1283A and a movable seat 1284A removably installed on the fixed seat 1283A up and down. The fixed seat 1283A is fixedly installed on the rear board main body 122A. The top of the movable seat 1284A is capable of abutting against the bottom of the unlocking board 124A. The bottom of the leaf spring 125A abuts against the bottom edge 1221A of the rear board main body 122A. Thus, the bottom of the leaf spring 125A is configured to keep still relative to the bottom edge 1221A of the rear board main body 122A. The top of the leaf spring 125A abuts against the movable seat 1284A. Thus, the top of the leaf spring 125A is configured to abut against the bottom of the unlocking board 124A, and the leaf spring 125A is hidden between the fixed seat 1283A and the movable seat 1284A to avoid sundries from being blocked in the leaf spring 125A to result in a failure of the leaf spring 125A.

Continuing to refer to FIG. 39, FIG. 40 and FIG. 42, the fixed seat 1283A includes a seat cylinder 12831A and a locking arm 12832A extending outward from the seat cylinder 12831A. The seat cylinder 12831A is provided with a movable cavity 128311A, a bottom opening 128312A, a top opening 128313A and at least one limit slot 128314A. The bottom opening 128312A and the top opening 128313A are formed in the bottom and the top of the movable cavity 128311A, respectively. The limit slot 128314A communicates with the movable cavity 128311A and extends in a direction from the bottom opening 128312A to the top opening 128313A. The locking arm 12832A is locked on the rear board main body 122A. For example, the locking arm 12832A can be locked on the rear board main body 122A with screws so as to fixedly install the fixed seat 1283A on the rear board main body 122A. The movable seat 1284A includes a seat body 12841A and at least one limit arm 12842A extending from the bottom of the seat body 12841A to a side of the seat body 12841A. The seat body 12841A is provided with a first spring slot 128411A. The movable seat 1284A is installed in the movable cavity 128311A of the seat cylinder 12831A through the bottom opening 128312A of the seat cylinder 12831A. The top of the seat body 12841A is capable of extending to the outside of the seat cylinder 12831A through the top opening 128313A of the seat cylinder 12831A. The limit arm 12842A of the movable seat 1284A is slidably arranged in the limit slot 128314A of the seat cylinder 12831A. The top of the leaf spring 125A is accommodated in the first spring slot 128411A of the seat body 12841A. Thus, the bottom of the leaf spring 125A is capable of reliably abutting against the bottom edge 1221A of the rear board main body 122A, and the leaf spring 125A is hidden between the fixed seat 1283A and the movable seat 1284A to avoid sundries from being blocked in the leaf spring 125A to result in a failure of the leaf spring 125A.

The limit arm 12842A of the movable seat 1284A is slidably arranged in the limit slot 128314A of the seat cylinder 12831A, so the movable seat 1284A cannot rotate in the process of moving up and down relative to the fixed seat 1283A, and the movable seat 1284A cannot be separated from the fixed seat 1283A to ensure the reliability of the rear board unit 12.

Preferably, continuing to refer to FIG. 39 and FIG. 40, the seat cylinder 12831A is provided with the two limit slots 128314A. The two limit slots 128314A are symmetrically arranged on two opposite sides of the movable cavity 128311A. Correspondingly, the movable seat 1284A includes the two limit arms 12842A. The two limit arms 12842A are symmetrically arranged on two opposite sides of the bottom of the seat body 12841A. The two limit arms 12842A of the movable seat 1284A are slidably arranged in the two limit slots 128314A of the seat cylinder 12831A, respectively.

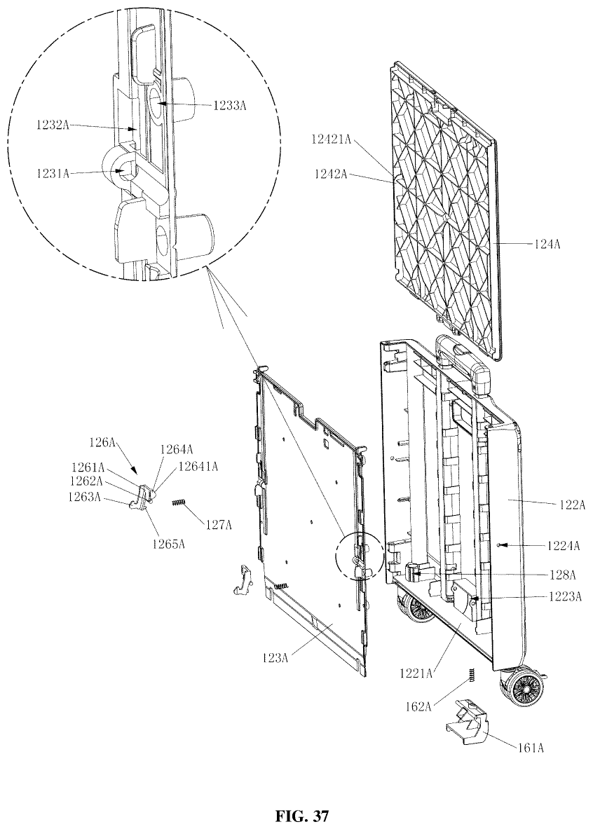

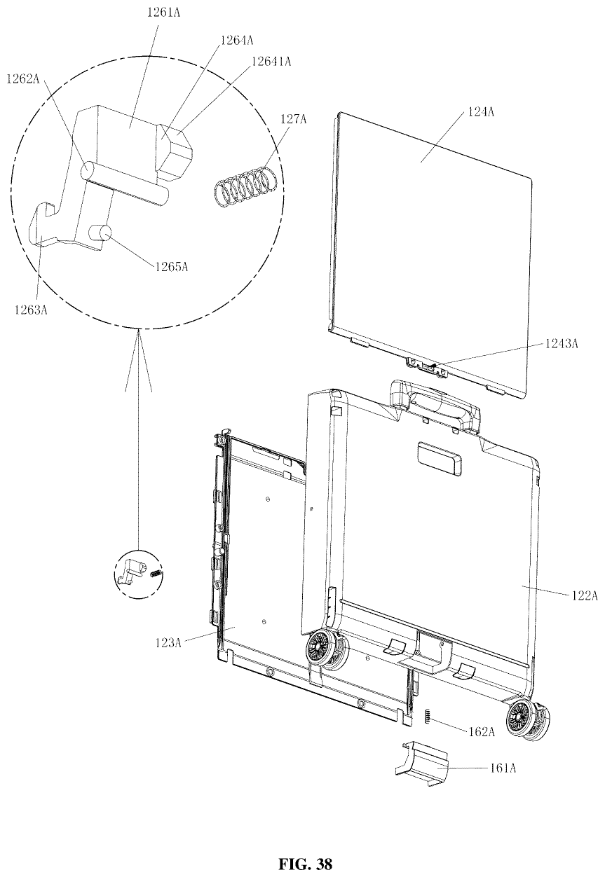

Referring to FIG. 37 and FIG. 38, the locking hook 126A includes a lock body 1261A, a pivotal axis 1262A, a hook body 1263A and a driven block 1264A. The pivotal axis 1262A is arranged at the bottom of the lock body 1261A. The hook body 1263A is arranged in front of the lock body 1261A, and the driven block 1264A is arranged at the back of the lock body 1261A. The driven block 1264A is provided with a driven inclined plane 12641A. Preferably, the locking hook 126A is of a one-piece structure.

A side of the unlocking board 124A is provided with at least one driving block 1242A. The driving block 1242A is provided with a driving inclined plane 12421A. The baffle 123A is provided with a first pivotal hole 1231A and a baffle channel 1232A adjacent to the first pivotal hole 1231A. The baffle channel 1232A of the baffle 123A corresponds to the driving block 1242A of the unlocking board 124A in a horizontal direction. The rear board main body 122A is provided with a second pivotal hole 1224A. The second pivotal hole 1231A of the rear board main body 123A corresponds to the first pivotal hole 1224A of the rear board main body 122A in a horizontal direction. Two opposite ends of the pivotal axis 1262A of the locking hook 126A are rotatably installed in the first pivotal hole 1231A of the baffle 123A and the second pivotal hole 1224A of the rear board main body 122A, respectively. The driven block 1264A extends to the driving block 1242A of the unlocking board 124a through the baffle channel 1232A of the baffle 123A. The driven inclined plane 12641A of the driven block 1264A is laminated to the driving inclined plane 12421A of the driving block 1242A. An end of the locking spring 127A abuts against the bottom of the hook body 1263A of the locking hook 126A.

Preferably, the locking hook 126A further includes a locking column 1265A. The locking column 1265A is arranged at the bottom of the hook body 1263A. The locking column 1265A extends to the interior of the locking spring 127A at one end of the locking spring 127A to avoid this end of the locking spring 127A from sliding relative to the hook body 1263A, so that the end of the locking spring 127A stably abuts against the hook body 1263A.

Preferably, a side of the baffle 123A is provided with at least one accommodation hole 1233A. The accommodation hole 1233A is located at the back of the hook body 1263A of the locking hook 126A. One end of the locking spring 127A is accommodated in the accommodation hole 1233A of the baffle 123A. Thus, this end of the locking spring 127A can stably abut against the baffle 123A to avoid this end of the locking spring 127A from sliding relative to the baffle 123A.

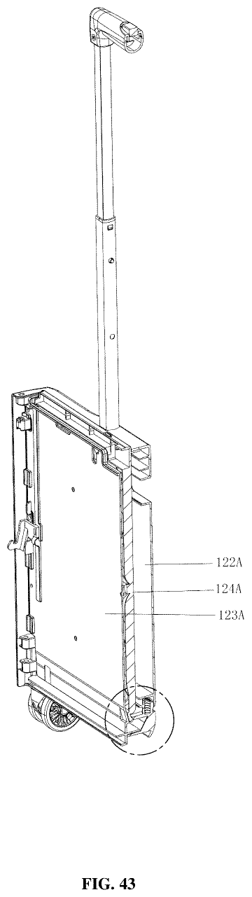

Referring to FIG. 43 to FIG. 49, the storage device 10 further includes a locking unit 16A. When the unlocking board 124A is located between the rear board main body 122A and the baffle 123A and the unlocking board 124A and the rear board main body 122A are matched with each other so that the leaf spring 125A is in a compressed state, the locking unit 16A locks the unlocking board 124A for blocking the unlocking board 124A from generating upward movement relative to the rear board main body 122A. When the locking unit 16A releases the unlocking board 124A, the leaf spring 125A pushes the unlocking board 124A to move upward in the process of recovering an initial state.

In this specific example of the cart in the present disclosure as shown in FIG. 36 to FIG. 49, the locking unit 16A is operably arranged on the rear board main body 122A, wherein the locking unit 16A is used for locking or releasing the unlocking board 124A. Specifically, the locking unit 16A is operably arranged at the bottom of the rear board main body 122A, wherein the locking unit 16A is used for locking or releasing the bottom of the unlocking board 124A.

Specifically, the bottom of the unlocking board 124A is provided with a locking slot 1243A. The rear board main body 122A is provided with an operation channel 1223A. The locking unit 16A includes an operation part 161A and a reset part 162A. The operation part 161A is operably installed on the rear board main body 122A and corresponds to the operation channel 1223A. The reset part 162A is arranged between the operation part 161A and the rear board main body 122A for resetting the operation part 161A after being operated. The operation part 161A is provided with a locking piece 1611A. The locking piece 1611A of the operation part 161A is capable of stretching into or exiting the locking slot 1243A of the unlocking board 124A. When the locking piece 1611A of the operation part 161A stretches into the locking slot 1243A of the unlocking board 124A, the locking unit 16A locks the unlocking board 124A for blocking the unlocking board 124A from generating upward movement relative to the rear board main body 122A. Correspondingly, when the locking piece 1611A of the operation part 161A exits the locking slot 1243A of the unlocking board 124A, the locking unit 16A releases the unlocking board 124A. The leaf spring 125A pushes the unlocking board 124A to move upward in the process of recovering an initial state.

Preferably, the operation part 161A is rotatably installed on the rear board main body 122A. When the operation part 161A is not driven to rotate, the locking piece 1611A of the operation part 161A stretches into the locking slot 1243A of the unlocking board 124A by means of the reset part 162A. When the operation part 161A is driven to rotate, the locking piece 1611A of the operation part 161A exits the locking slot 1243A of the unlocking board 124A and the reset part 162A deforms. The specific type of the reset part 162A is not limited in the cart in the present disclosure, and may be a pressure spring or a torsional spring. More preferably, the operation part 161A is located in the operation channel 1223A of the rear board main body 122A.

Further, the operation part 161A is provided with a stressed part 1612A. The user can apply force to the operation part 161A by means of the stressed part 1612A, so that the operation part 161A rotates relative to the rear board main body 122A. Preferably, the user may apply force to the stressed part 1612A of the operation part 161A with feet to drive the operation part 161A to rotate relative to the rear board main body 122A.

Further, the operation part 161A is provided with a second spring slot 1613A. The bottom of the reset part 162A is accommodated in the second spring slot 1613A of the operation part 161A, so that the reset part 162A is reliably arranged between the operation part 161A and the rear board main body 122A.

When the storage device 10 is in the unfolded state, each of the side board units 13 and each of the bottom board units 14 are unfolded, so that the front board unit 11, the rear board unit 12, each of the side board units 13 and each of the bottom board units 14 are enclosed to form the storage cavity 100. At this time, the hook body 1263A of the locking hook 126A is located in an avoidance slot 1326 of the second side board 132 of the side board unit 13. The main board long side 1413 of the bottom board main board 141 of one of the bottom board units 14 leans against the bottom of the front board unit 11, and the main board long side 1413 of the bottom board main board 141 of the other of the bottom board units 14 leans against the bottom of the rear board unit 12. The first main board leaning buckle 1415 of the bottom board main board 141 leans against the bottom board sub-board 142 and is accommodated in the first sub-board leaning slot 1427 of the bottom board sub-board 142. The first sub-board leaning buckle 1426 of the bottom board sub-board 142 leans against the bottom board main board 141 and is accommodated in the first main board leaning slot 1416 of the bottom board main board 141. The second sub-board leaning buckle 1428 of the bottom board sub-board 142 of one of the bottom board units 14 leans against the bottom board sub-board 142 of the other of the bottom board units 14 and is accommodated in the second sub-board leaning slot 1429. The second main board leaning buckle 1417 of the bottom board main board 141 of one of the bottom board units 14 leans against the bottom board main board 141 of the other of the bottom board units 14 and is accommodated in the second main board leaning slot 1418 of this bottom board main board 141.

When the storage device 10 is in the folded state, each of the side board units 13 and each of the bottom board units 14 are folded and clamped between the front board unit 11 and the rear board unit 12. The blocked part 129 is blocked by the top edge 1222 of the rear board main body 122A. The bottom edge 1221 of the rear board main body 122A of the unlocking board 124A compresses the leaf spring 125A so that the leaf spring 125A is kept in a compressed state. The hook body 1263A of the locking hook 126A hooks the locking protrusion 112 of the front board unit 11.

In the process that the storage device 10 is switched to the folded state from the unfolded state, the middle part of the side board unit 13 is pushed in a direction towards the storage cavity 100 of the storage device 10, so that the first side board 131 and the second side board 132 rotate around a rotating shaft of the first side board 131 and the second side board 132 to fold the side board unit 13 inward. At the same time, the first side board 131 and the front board unit 11 rotate around a rotating shaft of the first side board 131 and the front board unit 11. The second side board 132 and the rear board unit 12 rotate around a rotating shaft of the second side board 132 and the rear board unit 12. The bottom board sub-board 142 and the bottom board main board 141 of the bottom board unit 14 rotate around a rotating shaft (a folding shaft) of the bottom board sub-board 142 and the bottom board main board 142 so that the bottom board unit 14 is folded upward. The bottom board sub-board 142 of one of the bottom board units 14 and the first side board 131 rotate around a rotating shaft of the bottom board sub-board 142 and the first side board 131. The bottom board sub-board 142 of the other of the bottom board units 14 and the second side board 132 rotate around a rotating shaft of this bottom board sub-board 142 and the second side board 132. The front board unit 11 and the rear board unit 12 get close to each other. When the front board unit 11 is overlapped on the rear board unit 12, the hook body 1263A of the locking hook 126A hooks the locking protrusion 112 of the front board unit 11, so that the rear board unit 12 locks the front board unit 11, and the storage device 10 is kept in the folded state.

In the process that the storage device 10 is switched to the unfolded state from the folded state, force is applied to the stressed part 1612A of the operation part 161A with feet for driving the operation part 161A to rotate relative to the rear board main body 122A, so that the locking piece 1611A of the operation part 161A exits the locking slot 1241A of the unlocking board 124A. At this time, the locking unit 16A releases the unlocking board 124A, and then the leaf spring 125A pushes the unlocking board 124A to move upward in the process of recovering an initial state. The driving block 1242A of the unlocking board 124A and the driven block 1264A of the locking hook 126A coordinate with each other, so that the locking hook 126A rotates to allow the hook body 1263A of the locking hook 126A from being separated from the locking protrusion 112 of the front board unit 11. At this time, the rear board unit 12 releases the front board unit 11. Subsequently, when the front board unit 11 and the rear board unit 12 get away from each other by pulling the front board unit 11 and the rear board unit 12, each of the side board units 13 and each of the bottom board units 14 are unfolded to allow the storage device 10 to be switched to the unfolded state.

It should be understood by those skilled in the art that the embodiments of the present disclosure shown in the above description and the attached figures are only regarded as examples and do not limit the present disclosure. The purposes of the present disclosure have been completely and effectively achieved. The functional and structural principles of the present disclosure have been shown and described in the examples, and the embodiments of the present disclosure may be modified or modified in any way without departing from the principles.

What is claimed is:

1. A foldable storage device, comprising:
a front board unit;
a rear board unit, wherein the rear board unit and the front board unit are arranged face to face;
two side board units, wherein a middle part of the side board unit is foldable inward, two opposite sides of one of the side board units being rotatably installed on one side of the front board unit and one side of the rear board unit, respectively, and two opposite sides of the other of the side board units being rotatably installed on the other side of the front board unit and the other side of the rear board unit, respectively; and
two bottom board units, wherein two opposite ends of the bottom board unit are foldable upward, two opposite ends of one of the bottom board units being rotatably installed at one end of each of the two side board units at the bottom of the side board unit, respectively, two opposite ends of the other of the bottom board units being rotatably installed at the other ends of the two side board units at the bottom of the side board unit, respectively, and an acute included angle being formed between a folding shaft of the bottom board unit and a rotating shaft of the bottom board unit and the side board unit.

2. The storage device according to claim 1, wherein the bottom board unit comprises a triangular bottom board main board and two triangular bottom board sub-boards, the bottom board main board being provided with a first main board short side, a second main board short side and a main board long side, the bottom board sub-board being provided with a first sub-board short side, a second sub-board short side and a sub-board long side, the sub-board long side of one of the bottom board sub-boards and the first main board short side of the bottom board main board being connected by a shaft to form one folding shaft of the bottom board unit, the sub-board long side of the other of the bottom board sub-boards and the second main board short side of the bottom board main board being connected by a shaft to form the other folding shaft of the bottom board unit, the first sub-board short sides of the two bottom board sub-boards of one of the bottom board units and one end of each of the two side board units being connected by shafts to form a rotating shaft of the bottom board unit and the side board unit, and the first sub-board short sides of the two bottom board sub-boards of the other of the bottom board units and the other ends of the two side board units being connected by shafts to form a rotating shaft of the bottom board unit and the side board unit.

3. The storage device according to claim 2, wherein after the bottom board unit is unfolded, a connected position of the bottom board main board and the bottom board sub-board is raised upward.

4. The storage device according to claim 2, wherein after the bottom board unit is unfolded, an included angle α is formed between a top surface of the bottom board main board and a top surface of the bottom board sub-board and an included angle β is formed between a bottom surface of the bottom board main board and a bottom surface of the bottom board sub-board, and wherein the included angle α is larger than 180° and the included angle β is smaller than 180°.

5. The storage device according to claim 1, wherein the front board unit is provided with at least one locking protrusion and the rear board unit comprises a rear board main body, a baffle, an unlocking board, at least one leaf spring, at least one locking hook and at least one locking spring, the baffle being installed on the inner side of the rear board main body, the unlocking board being removably arranged between the rear board main body and the baffle, the leaf spring being configured to have one end keeping still relative to a bottom edge of the rear board main body and the other end abutting against the bottom of the unlocking board, the locking hook being rotatably installed on the baffle and drivably connected to the unlocking board, the locking hook being capable of hooking the locking protrusion of the front board unit, and the locking spring being configured to have one end abutting against the baffle and the other end abutting against the locking hook.

6. The storage device according to claim 5, wherein the locking hook comprises a lock body, a pivotal axis, a hook body and a driven block, the pivotal axis being arranged at the bottom of the lock body, the hook body being arranged in front of the lock body, the driven block being arranged at the back of the lock body, and the driven block being provided with a driven inclined plane; wherein a side of the unlocking board is provided with at least one driving block, the driving block being provided with a driving inclined plane; wherein the baffle is provided with a pair of pivotal holes and a baffle channel adjacent to the pivotal holes, the baffle channel of the baffle corresponding to the driving block of the unlocking board in a horizontal direction; wherein two opposite ends of the pivotal axis of the locking hook are rotatably installed in the pair of pivotal holes of the baffle, respectively, the driven block extending to the driving block of the unlocking board through the baffle channel of the baffle, the driven inclined plane of the driven block being laminated to the driving inclined plane of the driving block, and an end of the locking spring abutting against the bottom of the hook body.

7. The storage device according to claim 6, wherein the rear board unit comprises a blocked part, the blocked part being arranged on the top of the unlocking board, the blocked part being capable of being blocked or released by a top edge of the rear board main body, when the blocked part is blocked by the top edge of the rear board main body, the leaf spring is in a compressed state by the unlocking board and the rear board main body, when the blocked part is released by the top edge of the rear board main body, the leaf spring pushes the unlocking board to move upward, so that the driving block and the driven block coordinate with each other for driving the locking hook to rotate.

8. The storage device according to claim 7, wherein the rear board main body is provided with an operation channel, a part, adjacent to the blocked part, of the unlocking board corresponding to the operation channel of the rear board main body, or the blocked part corresponding to the operation channel of the rear board main body.

9. The storage device according to claim 5, wherein the locking hook comprises a lock body, a pivotal axis, a hook body and a driven block, the pivotal axis being arranged at the bottom of the lock body, the hook body being arranged in front of the lock body, the driven block being arranged at the back of the lock body, and the driven block being provided with a driven inclined plane; wherein a side of the unlocking board is provided with at least one driving block, the driving block being provided with a driving inclined plane; wherein the baffle is provided with a first pivotal hole and a baffle channel adjacent to the first pivotal hole, the baffle channel of the baffle corresponding to the driving block of the unlocking board in a horizontal direction, the rear board main body being provided with a second pivotal hole, and the second pivotal hole of the rear board main body corresponding to the first pivotal hole of the baffle in a horizontal direction; wherein two opposite ends of the pivotal axis of the locking hook are rotatably installed in the first pivotal hole of the baffle and the second pivotal hole of the rear board main body, respectively, the driven block extending to the driving block of the unlocking board through the baffle channel of the baffle, the driven inclined plane of the driven block being laminated to the driving inclined plane of the driving block, and an end of the locking spring abutting against the bottom of the hook body.

10. The storage device according to claim 5, wherein the rear board unit comprises a spring seat, the spring seat comprising a fixed seat and a movable seat removably installed on the fixed seat up and down, the fixed seat being fixedly installed on the rear board main body, the top of the movable seat being capable of abutting against the bottom of the unlocking board, the bottom of the leaf spring abutting against the bottom edge of the rear board main body, and the top of the leaf spring abutting against the movable seat.

11. The storage device according to claim 10, wherein the fixed seat comprises a seat cylinder and a locking arm extending outward from the seat cylinder, the locking arm being locked on the rear board main body, the seat cylinder being provided with a movable cavity, a bottom opening, a top opening and at least one limit slot, the bottom opening and the top opening being formed in the bottom and the top of the movable cavity, respectively, and the limit slot communicating with the movable cavity and extending in a direction from the bottom opening to the top opening; wherein the movable seat comprises a seat body and at least one limit arm extending from the bottom of the seat body to a side of the seat body, the seat body being provided with a first spring slot, the movable seat being installed in the movable cavity of the seat cylinder through the bottom opening of the seat cylinder, the top of the seat body being capable of extending to the outside of the seat cylinder through the top opening of the seat cylinder, the limit arm of the movable seat being slidably arranged in the limit slot of the seat cylinder, and the top of the leaf spring being accommodated in the first spring slot of the seat body.

12. The storage device according to claim 9, wherein the storage device comprises a locking unit, the locking unit being operatively arranged on the rear board main body, and the locking unit being configured to lock or release the unlocking board.

13. The storage device according to claim 12, wherein the unlocking board is provided with a locking slot, the rear board main body being provided with an operation channel, the locking unit comprising an operation part and a reset part, the operation part being operably installed on the rear board main body and corresponding to the operation channel, the reset part being arranged between the operation part and the rear board main body for resetting the operation part after being operated, the operation part being provided with a locking piece, the locking piece of the operation part being configured to be capable of stretching into or exiting the locking slot of the unlocking board, when the locking piece stretches into the locking slot of the unlocking board, the locking unit locking the unlocking board, and when the locking piece exits the locking slot of the unlocking board, the locking unit releasing the unlocking board.

14. The storage device according to claim 13, wherein the operation part is rotatably installed at the bottom of the rear board main body.

15. A foldable storage device, comprising a front board unit, a rear board unit, two side board units and two bottom board units and having an unfolded state and a folded state;
wherein each of the side board units comprises a first side board and a second side board, respectively, one side of the first side board and one side of the second side board being connected by a shaft, the other side of the first side board and one side of the front board unit being connected by a shaft, and the other side of the second side board and one side of the rear board unit being connected by a shaft;
wherein each of the bottom board units comprises a triangular bottom board main board and two triangular bottom board sub-boards, respectively, the bottom board main board being provided with a first main board short side, a second main board short side and a main board long side, the bottom board sub-board being provided with a first sub-board short side, a second sub-board short side and a sub-board long side, the sub-board long sides of the two bottom board sub-boards being connected to the first main board short side and the second main board short side of the bottom board main board by shafts, respectively, the first sub-board short sides of the two bottom board sub-boards of one of the bottom board units being connected to the bottoms of the first side boards of the two side board units by shafts, respectively, the first sub-board short sides of the two bottom board sub-boards of the other of the bottom board units being connected to the bottoms of the second side boards of the two side board units by shafts, respectively, when the first side board and the second side board rotate relatively, the bottom board sub-board rotating synchronously with the first side board or the second side board relative to the bottom board main board, so that the storage device is capable of being switched in the state and the folded state.

16. The storage device according to claim 15, wherein when the storage device is in the unfolded state, a connected position of the bottom board main board and the bottom board sub-board is raised upward.

17. The storage device according to claim 15, wherein when the storage device is in the unfolded state, an included angle α is formed between a top surface of the bottom board main board and a top surface of the bottom board sub-board and an included angle β is formed between a bottom surface of the bottom board main board and a bottom surface of the bottom board sub-board, and wherein the included angle α is larger than 180° and the included angle β is smaller than 180°.

18. The storage device according to claim 15, wherein when the storage device is in the unfolded state, the main board long side of the bottom board main board of one of the bottom board units leans against the bottom of the front board unit, the main board long side of the bottom board main board of the other of the bottom board units leans against the bottom of the rear board unit, and the second sub-board short side of each bottom board sub-board of one of the bottom board units and the second sub-board short side of each bottom board sub-board of the other of the bottom board units lean against each other.

19. The storage device according to claim 18, wherein the bottom board main board is provided with at least one first main board leaning buckle and at least one first main board leaning slot on the first main board short side and the second main board short side, respectively, the first main board leaning buckle and the first main board leaning slot being staggered mutually; wherein the bottom board sub-board is provided with at least one first sub-board leaning buckle and at least one first sub-board leaning slot on the sub-board long side, respectively, the first sub-board leaning buckle and the first sub-board leaning slot being staggered mutually; and wherein when the storage device is in the unfolded state, the first main board leaning buckle of the bottom board main board leans against the bottom board sub-board and is accommodated in the first sub-board leaning slot of the bottom board sub-board, and the first sub-board leaning buckle of the bottom board sub-board leans against the bottom board main board and is accommodated in the first main board leaning slot of the bottom board main board.

20. The storage device according to claim 19, wherein the first main board leaning buckle of the bottom board main board is provided with a first main board buckle body, the first main board leaning slot of the bottom board main board being provided with a first main board buckle slot, the first sub-board leaning buckle of the bottom board sub-board being provided with a first sub-board buckle body, the first sub-board leaning slot of the bottom board sub-board being provided with a first sub-board buckle slot, the first main board buckle body of the first main board leaning buckle being capable of being buckled in the first sub-board buckle slot of the bottom board sub-board, and the first sub-board buckle body of the first sub-board leaning buckle being capable of being buckled in the first main board buckle slot of the bottom board main board.

21. The storage device according to claim 19, wherein the bottom board sub-board is provided with at least one second sub-board leaning buckle and at least one second sub-board leaning slot on the second sub-board short side, the second sub-board leaning buckle and the second sub-board leaning slot being staggered mutually; and wherein when the storage device is in the unfolded state, the second sub-board leaning buckle of one of the bottom board sub-boards leans against the other of the bottom board sub-boards and is accommodated in the second sub-board leaning slot of this bottom board sub-board.

22. The storage device according to claim 15, wherein a portion, located between the second sub-board short sides of the two bottom board sub-boards, of the bottom board main board is provided with at least one second main board leaning buckle and at least one second main board leaning slot; and wherein when the storage device is in the unfolded state, the second main board leaning buckle of the bottom board main board of one of the bottom board units leans against the other of the bottom board main boards and is accommodated in the second main board leaning slot of this bottom board main board.

23. The storage device according to claim 22, wherein the second main board leaning buckle of the bottom board main board is provided with a second main board buckle body, the second main board leaning slot of the bottom board main board being provided with a second main board buckle slot, the second main board buckle body of the second main board leaning buckle of one of the bottom board main boards being capable of being buckled in the second main board buckle slot of the second main board leaning slot of the other of the bottom board main boards.

24. The storage device according to claim 15, wherein the front board unit is provided with at least one locking protrusion and the rear board unit comprises a rear board main body, a baffle, an unlocking board, at least one leaf spring, at least one locking hook and at least one locking spring, the baffle being installed on the inner side of the rear board main body, the unlocking board being removably arranged between the rear board main body and the baffle, the leaf spring being configured to have one end keeping still relative to a bottom edge of the rear board main body and the other end abutting against the bottom of the unlocking board, the locking hook being rotatably installed on the baffle and drivably connected to the unlocking board, the locking hook being capable of hooking the locking protrusion of the front board unit, and the locking spring being configured to have one end abutting against the baffle and the other end abutting against the locking hook.

25. A cart, comprising:
a pull rod;
a set of wheels; and
the storage device according to claim 1, wherein the pull rod is installed on the rear board unit, wherein the wheels are installed at the bottom of the front board unit and the bottom of the rear board unit, respectively, or the wheels are installed at the bottom of the rear board unit.

26. A cart, comprising:
a pull rod;
a set of wheels; and
the storage device according to claim 15, wherein the pull rod is installed on the rear board unit, wherein the wheels are installed at the bottom of the front board unit and the bottom of the rear board unit, respectively, or the wheels are installed at the bottom of the rear board unit.
